(19) United States
(12) Patent Application Publication
(10) Pub. No.: US 2025/0317710 A1
(43) Pub. Date: Oct. 9, 2025

(54) ELECTRONIC DEVICE AND METHOD FOR WIRELESS COMMUNICATION, AND COMPUTER-READABLE STORAGE MEDIUM

(71) Applicants: Lantao LI, Beijing (CN); Sony Group Corporation, Tokyo (JP)

(72) Inventor: Lantao LI, Beijing (CN)

(73) Assignee: Sony Group Corporation, Tokyo (JP)

(21) Appl. No.: 18/864,925

(22) PCT Filed: May 16, 2023
(86) PCT No.: PCT/CN2023/094480

§ 371 Date: Nov. 12, 2024

(30) Foreign Application Priority Data
May 23, 2022 (CN) 202210565256.1

(51) Int. Cl. H04W 4/029; H04W 4/40; H04W 4/50; H04W 28/02

(52) U.S. Cl. CPC H04W 4/029; H04W 4/40; H04W 4/50; H04W 28/0268

(57) ABSTRACT

The present disclosure relates to an electronic device and method for wireless communication, and a computer-readable storage medium. The electronic device for wireless communication comprises a processing circuit, and the processing circuit is configured to: on the basis of a task request, which is received from a user equipment located in the service range of the electronic device, determine, for the user equipment, at least one target task to be initiated, wherein each target task is executed according to a corresponding operating mode, and the task request comprises a task list having at least one target task and a list for indicating the priority of the operating mode.

This application claims priority to Chinese Patent Application No. 202210565256.1 titled “ELECTRONIC DEVICE AND METHOD FOR WIRELESS COMMUNICATION, AND COMPUTER-READABLE STORAGE MEDIUM”, filed on May 23, 2022 with the China National Intellectual Property Administration (CNIPA), which is incorporated herein by reference in its entirety.

### FIELD

The present disclosure relates to the technical field of wireless communication, and in particular to an electronic apparatus and method for wireless communication and a computer-readable storage medium. More specifically, the present disclosure relates to initiation and switching of a target task.

### BACKGROUND

In the scenarios of remote driving/manipulation which are network-based normal work types, remotely manipulated vehicles, unmanned aerial vehicles, robots, and the like, usually have a large movement range. Therefore, the remotely manipulated vehicles, unmanned aerial vehicles, robots, and the like, need to promptly adjust their target tasks and corresponding work modes based on a current or predicted network status.

### SUMMARY

A brief summary of the present disclosure is given below, to provide a basic understanding of some aspects of the present disclosure. It should be understood that the following summary is not an exhaustive summary of the present disclosure. It does not intend to determine a key or important part of the present disclosure, nor does it intend to limit the scope of the present disclosure. Its objective is merely to present concepts in a simplified form, which serves as a preamble of a more detailed description to be discussed later.

According to an aspect of the present disclosure, an electronic apparatus for wireless communications is provided. The electronic apparatus includes processing circuitry configured to: determine, based on a task request received from user equipment located within a service range of the electronic apparatus, at least one target task to be initiated for the user equipment, where each target task is performed according to a corresponding work mode, and the task request includes a task list having the at least one target task and a list indicating a priority of the work mode. In an embodiment according to the present disclosure, the electronic apparatus can determine the target task for the user equipment based on the task request received from the user equipment, so that an applicability of determining the target task is improved.

According to an aspect of the present disclosure, an electronic apparatus for wireless communications is provided. The electronic apparatus includes processing circuitry configured to trigger a request for processing a protocol data unit (PDU) session when user equipment located within a service range of the electronic apparatus is to switch from a current task to a to-be-switched task, where a first QoS flow in a first PDU session corresponding to the current task is related to a second QoS flow in a second PDU session corresponding to the to-be-switched task. In an embodiment of the present disclosure, the first QoS flow in the first PDU session corresponding to the current task is related to the second QoS flow in the second PDU session corresponding to the to-be-switched task, so that situations of a long time required to switch QoS or a high probability of process failure are avoided.

According to an aspect of the present disclosure, an electronic apparatus for wireless communications is provided. The electronic apparatus includes processing circuitry configured to send a task request to a network-side device serving the electronic apparatus, for the network-side device to determine at least one target task to be initiated for the electronic apparatus, where each target task is performed according to a corresponding work mode, and the task request includes a task list having the at least one target task and a list indicating a priority of the work mode. In an embodiment according to the present disclosure, the electronic apparatus sends the task request to the network-side device for determining the target task for the electronic apparatus, so that an applicability of determining the target task is improved.

According to an embodiment of the present disclosure, an electronic apparatus for wireless communications is provided. The electronic apparatus includes processing circuitry configured to cause, when the electronic apparatus is to switch from a current task to a to-be-switched task, a network-side device serving the electronic apparatus to trigger a request for processing a protocol data unit (PDU) session, where a first QoS flow in a first PDU session corresponding to the current task is related to a second QoS flow in a second PDU session corresponding to the to-be-switched task. In an embodiment of the present disclosure, the first QoS flow in the first PDU session corresponding to the current task is related to the second QoS flow in the second PDU session corresponding to the to-be-switched task, so that situations of a long time required to switch QoS or a high probability of process failure are avoided.

According to an aspect of the present disclosure, a method for wireless communications is provided. The method includes: determining, based on a task request received from user equipment located within a service range of an electronic apparatus, at least one target task to be initiated for the user equipment, where each target task is performed according to a corresponding work mode, and the task request includes a task list having the at least one target task and a list indicating a priority of the work mode.

According to an aspect of the present disclosure, a method for wireless communications is provided. The method includes: triggering a request for processing a protocol data unit (PDU) session when user equipment located within a service range of an electronic apparatus is to switch from a current task to a to-be-switched task, where a first QoS flow in a first PDU session corresponding to the current task is related to a second QoS flow in a second PDU session corresponding to the to-be-switched task.

According to an aspect of the present disclosure, a method for wireless communications is provided. The method includes: sending a task request to a network-side device serving an electronic apparatus, for the network-side device to determine at least one target task to be initiated for the electronic apparatus, where each target task is performed according to a corresponding work mode, and the task request includes a task list having the at least one target task and a list indicating a priority of the work mode.

According to an aspect of the present disclosure, a method for wireless communications is provided. The method includes: causing, when an electronic apparatus is to switch from a current task to a to-be-switched task, a network-side device serving the electronic apparatus to trigger a request for processing a protocol data unit (PDU) session, where a first QoS flow in a first PDU session corresponding to the current task is related to a second QoS flow in a second PDU session corresponding to the to-be-switched task.

According to other aspects of the present disclosure, there are further provided a computer program code and a computer program product for implementing the above-described methods for wireless communications, and a computer-readable storage medium having the computer program code for implementing the methods for wireless communications recorded thereon.

These and other advantages of the present disclosure become more apparent through preferred embodiments of the present disclosure described in detail below in conjunction with accompany drawings.

### BRIEF DESCRIPTION OF THE DRAWINGS

For a further illustration of the above and other advantages and features of the present disclosure, embodiments of the present disclosure are described in detail hereinafter in conjunction with accompanying drawings. The drawings, together with the detailed description below, are incorporated into and form a part of the specification. Elements having the same function and structure are denoted by same reference signs. It should be noted that the drawings illustrate merely typical embodiments of the present disclosure and should not be construed as a limitation to the scope of the present disclosure. In the drawings:

FIG. 1 shows a block diagram of functional modules of an electronic apparatus for wireless communications according to an embodiment of the present disclosure;

FIG. 2 is a schematic diagram illustrating resource allocation according to an embodiment of the present disclosure;

FIG. 3 is a schematic flow chart illustrating a process of confirming a task between an electronic apparatus and user equipment according to an embodiment of the present disclosure;

FIG. 4 shows a block diagram of functional modules of an electronic apparatus for wireless communications according to another embodiment of the present disclosure;

FIG. 5 is a flow chart illustrating a process of task switching according to an embodiment of the present disclosure;

FIG. 6 shows a block diagram of functional modules of an electronic apparatus for wireless communications according to a further embodiment of the present disclosure;

FIG. 7 shows a block diagram of functional modules of an electronic apparatus for wireless communications according to a further embodiment of the present disclosure;

FIG. 8 shows a flow chart of a method for wireless communications according to an embodiment of the present disclosure;

FIG. 9 shows a flow chart of a method for wireless communications according to another embodiment of the present disclosure;

FIG. 10 shows a flow chart of a method for wireless communications according to a further embodiment of the present disclosure;

FIG. 11 shows a flow chart of a method for wireless communications according to a further embodiment of the present disclosure;

FIG. 12 is a block diagram showing a first example of a schematic configuration of an eNB or gNB to which the technology of the present disclosure can be applied;

FIG. 13 is a block diagram showing a second example of a schematic configuration of an eNB or gNB to which the technology of the present disclosure can be applied;

FIG. 14 is a block diagram showing an example of a schematic configuration of a smart phone to which the technology of the present disclosure can be applied;

FIG. 15 is a block diagram showing an example of a schematic configuration of automobile navigation equipment to which the technology of the present disclosure can be applied; and

FIG. 16 is a block diagram of an exemplary structure of a universal personal computer in which the methods and/or apparatuses and/or systems according to the embodiments of the present invention can be implemented.

### DETAILED DESCRIPTION

Hereinafter, exemplary embodiments of the present disclosure will be described in conjunction with the accompanying drawings. For the sake of clarity and conciseness, not all features of an actual embodiment are described in the specification. However, it is to be appreciated that numerous implementation-specific decisions shall be made during developing any of such actual implementations so as to achieve specific objectives of a developer, for example, to comply with system- and service-related constraining conditions which will vary from one implementation to another. Furthermore, it should be understood that the development work, although may be complicated and time-consuming, is only a routine task for those skilled in the art benefiting from the present disclosure.

Here, it should be further noted that in order to avoid obscuring the present disclosure due to unnecessary details, only apparatus structures and/or processing steps closely related to the solutions according to the present disclosure are illustrated in the drawings, and other details less related to the present disclosure are omitted.

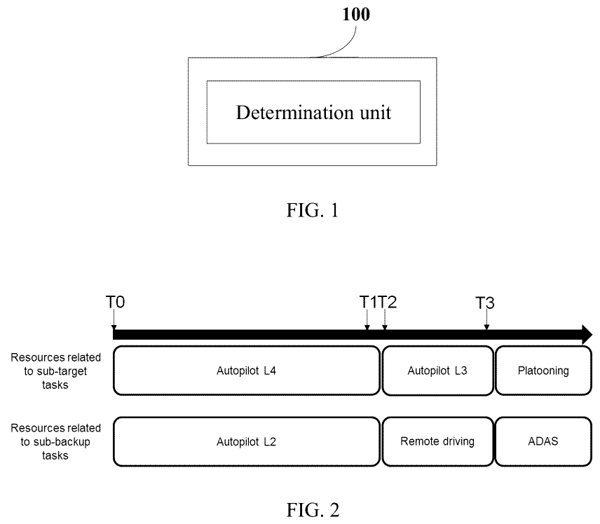

FIG. 1 shows a block diagram of functional modules of an electronic apparatus 100 for wireless communications according to an embodiment of the present disclosure.

As shown in FIG. 1, the electronic apparatus 100 includes a determination unit 101, which may be configured to determine, based on a task request received from user equipment located within a service range of the electronic apparatus 100, at least one target task to be initiated for the user equipment. Each target task is performed according to a corresponding work mode, and the task request includes a task list having the at least one target task and a list indicating a priority of the work mode.

The determination unit 101 may be implemented by one or more processing circuits. The processing circuitry may be implemented as a chip, for example.

The electronic apparatus 100 may serve as a network-side device in a wireless communication system.

The electronic apparatus 100 may, for example, be provided on a base station side or be communicatively connected to a base station. Here, it should be noted that the electronic apparatus 100 may be implemented at a chip level or at an apparatus level. For example, the electronic apparatus 100 may operate as the base station itself and may further include a memory, a transceiver (not shown), and other external devices. The memory may store related data information and programs that the base station needs to execute to achieve various functions. The transceiver may include one or more communication interfaces to support communications with different devices (such as user equipment (UE), another base station, and the like). An implementation of the transceiver is not specifically limited here. The base station may be an eNB or gNB, as an example. The electronic apparatus 100 may be a core network.

The wireless communication system according to the present disclosure may be a 5G NR (New Radio) communication system. Further, the wireless communication system according to the present disclosure may include a non-terrestrial network (NTN). Alternatively, the wireless communication system according to the present disclosure may further include a terrestrial network (TN). In addition, those skilled in the art can understand that the wireless communication system according to the present disclosure may be a 4G or 3G communication system.

As an example, the task request may be included in, for example, a service request message or a protocol data unit (PDU) session establishment request message.

As an example, a new set of signaling sets may be defined. For example, a task (mission) determination request message may be defined. The task request may be included in the task determination request message.

The target task may be a work target. For example, a vehicle as a UE (sometimes referred to as a “vehicle UE”) needs to travel to a fixed location; a robot as a UE (sometimes referred to as a “robot UE”) needs to load goods and transport the same to a certain location for unloading; and an unmanned aerial vehicle as a UE (sometimes referred to as an “unmanned aerial vehicle UE”) needs to inspect a certain location.

For example, the UE may determine the work mode according to a network status.

For example, for a vehicle UE, a list indicating priorities of work modes may indicate that the priorities from high to low are: formation driving mode, manual driving mode, emergency side parking mode, and the like. For example, on a suburban highway section, the list indicating priorities of work modes may indicate that the priorities from high to low are: autonomous driving, remote driving, formation driving, and the like. In an urban ring road section, the list indicating priorities of work modes may indicate that the priorities from high to low is: remote driving, assisted driving, manual driving, and the like.

In an embodiment according to the present disclosure, the electronic apparatus 100 can determine the target task for the user equipment based on the task request received from the user equipment, so that an applicability of determining the target task is improved.

As an example, the target task may include a mobility target task in which the user equipment reaches a predetermined geographical location and/or a motionless target task in which the user equipment works within a predetermined area.

As an example, the predetermined geographical location includes one or more geographical locations arranged sequentially and/or by priority.

As an example, the user equipment (UE) may be a vehicle operated and/or driven remotely. The work mode may include one of single-vehicle autonomous driving, formation driving, autonomous driving, remote monitoring, direct remote control, indirect remote control, and manual manipulation. For example, the target task may include: (one or more) travel destinations, expected arrival time, supported travel control modes (single-vehicle autonomous driving, formation driving, autonomous driving and remote monitoring, direct remote control, indirect remote control, and manual manipulation) and network requirements of the travel modes (communication QoS requirements, roadside unit sensing requirements, and network computing power requirements), a cruising range and charging requirement, and an impact of an energy-saving mode on the above parameters, and the like.

As an example, the user equipment may be an unmanned aerial vehicle (UAV). The work mode may include one of autonomous driving, formation driving, remote monitoring, direct remote control, indirect remote control, and manual manipulation. For example, target tasks may include: a flight cruising speed (considering that UAV of a fixed-wing type can reach a speed of more than 300 km/h), supported control types (autonomous driving, formation driving, remote monitoring, direct remote control, non-direct remote control, and manual manipulation), a flight duration limit, a flight target area (altitude, longitude and latitude range).

As an example, the user equipment may be mechanical equipment, such as a robot. For example, the target tasks may include a work target area, and a work requirement for communication QoS. The works may include works of a remotely driven vehicle or UAV (such as loading and unloading cargo, spraying pesticides, environmental monitoring, and the like), or works of special equipment (such as, control of a forklift, control of a gantry or crane, and the like).

In addition to the above examples, those skilled in the art may envisage other examples of the user equipment and the work mode, which are not described in detail here.

As an example, each target task is divided into one or more task segments according to time and/or geographic area. In each task segment, a sub-target task included in the target task and corresponding to the task segment is performed. The sub-target task is performed according to a corresponding sub-work mode included in the work mode for performing the target task. Therefore, by dividing the target task into sub-target tasks, the target task has a new granularity of a life cycle and can be composed of switching among multiple sub-target task.

For example, in a case where the target task is for a vehicle UE to move from location A to location C via location B, the target task may be divided into a sub-target task of reaching location B from location A and a sub-target task of reaching location C from location B.

For example, the target task may be divided into multiple sub-target tasks based on a current service map (a network status and task status corresponding to each area).

As an example, in each task segment, a sub-target task corresponding to the task segment is suspended or switched if any sub-work mode is interrupted.

As an example, the determination unit 101 may be configured to determine the target task according to resources it manages.

As an example, the resources managed include at least one of network communication resources, computing power resources, sensing capability resources, and work collaboration resources corresponding to the work mode.

As an example, the network communication resources include at least one of: a frequency band bandwidth resource of a Uu interface, a signal reflection resource of a reconfigurable intelligence surface, a relay capability resource of relay user equipment, and a contiguous PC5 coverage resources within the task segment.

As an example, the work collaboration resources include capability resources of other entities different from the electronic apparatus 100 and the user equipment required for performing the target task. For example, other entities may be component members for assisting positioning, formation, or the like.

For example, the electronic apparatus 100 determines the target task based on a network data analysis report request sent by the user equipment, available data and manageable resources (sensing capability coverage of a roadside unit, bandwidth of a communication band, a PC5 coverage of a reconfigurable intelligence surface (RIS)/relay node, an edge computing resource of a multi-access edge computing platform (MEC), and the like) at a network side (a core network, an access network, an application server, and the like), such as data analysis function (analysis mainly focuses on network service QoS) of a network data analysis function (NWDAF), location management function (LMF)/recording of a geographical location and speed of a vehicle UE by a base station, a signal measurement result/report of the base station, analysis of an application traffic and service status by an application server, and the like.

For example, the electronic apparatus 100 confirms an optional route based on a destination, a travel mode, a stopover/work point and other information indicated by the user equipment; confirms, according to the selected route, a corresponding base station, including a load status of each base station, a QoS guarantee status, a task type and level support status, and a signal range of each base station (for UAV, a height range is an important parameter); and finally confirms a selectable route based on a task load of roadside equipment corresponding to a route selected by the user equipment, an equipment sensor type, a network computing power (cloud computing, and edge computing), a road grade and congestion condition and the like. The confirmation includes prioritization of multiple optional routes, and the like.

For example, the electronic apparatus 100 performs task pre-planning based on whether there is an area corresponding to a task requirement of a non-traveling task required by the user equipment (such as fuel/power replenishment, autonomous loading and unloading, environmental monitoring, and pesticide spraying), and whether a network status, a computing capability, and a field-side sensing type corresponding to the area is capable of supporting a corresponding service.

For example, in a case where a destination or work target is not determined from the user equipment, the electronic apparatus 100 may perform the task pre-planning based on a current location of the UE, a device type of the UE, and a historical work target and historical travel route of the UE.

In a case that there are multiple solutions that can be used to complete the task of the UE, the electronic apparatus 100 needs to make a charging estimate based on network resource usage involved in the different solutions and a subscription type of the UE, and feeds back the estimation to the UE (and further presents to a user of the UE). Hence, a method for charging required network resources based on a task type is provided.

The electronic apparatus 100 may generate a report from the determined information and send the report to the user equipment.

In a case where the electronic apparatus 100 predicts that the network is overloaded or some tasks cannot be satisfied, the electronic apparatus 100 may deploy a vehicle-mounted relay, a mobile RIS and other devices to configure a wireless environment for the task in advance, that is, the electronic apparatus 100 needs to reserve a usage time and a usage area with an auxiliary network communication device.

To facilitate the above determination, the core network side may be added with a functional module, i.e., a service support module. Functions of the service support module may be implemented by an existing system management function (SMF)/point coordination function (PCF). Alternatively, a new network unit may be added to specifically implement relevant logic of the service support module (such as service supporting/management Function). The new functional module is connected with SMF/PCF. This service maintains a service map for vertical services supported by 3GPP. Service content (service type and service level) that can be supported within a certain regional range is determined based on regional range units (zone, cell, tracking area, routing area, and the like), according to network communication parameters (QOS records and analysis results, air interface resource usage), vertical service network control resource parameters (roadside unit (RSU) sensing capabilities, RSU D2D communication capabilities, edge computing capabilities, auxiliary communication facility coverage capabilities, and the like).

For example, after obtaining the task request, based on the service content (for example, a certain highway section may support high-level autonomous driving, remote driving, formation driving and other services; an urban ring road may support the remote driving and assisted driving services; and a urban ordinary road supports only the assisted driving) that can be supported by each road section and cell within a current management range (for example, a management range of Chaoyang District in Beijing), the service support module generates service content of different routes (the types of services that need to be carried out on each road) after a preliminary route planning is completed (for example, after completing a planning of two routes, where one passes through an urban ring road and the other one does not need to pass through the urban ring road). For example, in the assisted driving, when a vehicle is controlled by a driver, the vehicle UE prompts some non-visual road information, such as bursting in of pedestrian, bicycles approaching from behind, and the like. After the service support module sends the determined task content to other network functional units (AMF/SMF/PCF) of the core network, the network functional units of the core network send decision results to the UE. In addition, to generate the above results and maintain the vertical service map, the service support module needs to regionally divide road sections, cells, and the like, within the management range. Any location in the area needs to have (callable) vertical service support capabilities at a same level (for example, auxiliary positioning capabilities with a same accuracy, sensing capabilities at a same level, a same computing power redundancy, and the like); and any location in the area needs to have communication capabilities at a same level (according to log information of UEs in the area). Different work modes require different levels of vertical service support capabilities and communication capabilities. For example, the autonomous driving focuses on a communication capability of the PC5 interface and a roadside sensing capability; and the remote-manipulated driving relies on a communication capability of the Uu interface. For example, sensing ability includes a size of a sensing range (e.g., 50m, 100m, 150m, 200m, and the like) and/or an object sensing accuracy (percentage). For example, the log information may include a QoS parameter log of at least one of the rate, delay, and packet loss rate actually experienced by the UE, which may be subdivided into QOS logs of the PC5 access mode and the Uu access mode, respectively. For example, the service support module may obtain the above-mentioned information (information corresponding to the above examples) through a roadside units RSU, an edge computing device MEC, a sensing device and various types of resource management device corresponding to each road section and cell within the management range.

As an example, the target task has a corresponding backup task, and the backup task is a task to be performed in place of the target task when the target task is unable to be performed.

For example, the target task is for the vehicle UE to travel from location A to location C via location B. In this case, if the vehicle UE cannot travel to location C after arriving at location B (that is, the target task cannot be performed normally), a corresponding backup task may be that the vehicle UE stops at location B, returns to location A from location B, waits at location B until the vehicle UE can continue traveling to location C, and the like.

The UE has changes in service requirements and may actively trigger change in service content, such as change in a vehicle travel destination, change in machine work types, and the like.

In addition, the UE may passively accept takeover by a third-party terminal and network application server, such as temporary takeover of a vehicle by a roadside unit, a central cloud server and an edge computing unit, temporary dispatching intervention on a vehicle by a traffic management department, and airspace restriction on an UAV by an air traffic control department. An ordinary service-related third-party terminal may trigger the triggering of a specific UE (for example, a formation management/leader UE in the formation detects that a certain member UE behind has a service abnormality, and sends a message to the network-side device to indicate that an abnormality triggers switching of the backup task).

In the above situation, the UE needs the network-side device to update a relevant task and determine a task switching plan as early as possible according to a resource situation or a backup task plan negotiated in advance.

As an example, the determination unit 101 may be configured to generate a backup task based on a backup task request sent by the user equipment.

For example, the backup task request may be included in, for example, a service request message or a PDU session establishment request message.

For example, the backup task request may be included in a new signaling set such as a defined task determination request message.

As an example, the backup task request includes information regarding whether the user equipment accepts to determine the backup task by the electronic apparatus 100.

As an example, the backup task request further includes information regarding whether the user equipment continues performing the target task.

As an example, the backup task request further includes a redundancy requirement regarding the backup task. For example, the redundancy requirement includes whether a redundant backup task is required. As a result, a redundancy of the network in supporting work tasks can be enhanced. For example, the redundancy of the network in supporting work tasks are enhanced for V2X and UAV services of the remote driving and the autonomous driving.

As an example, the target task is switched to a corresponding backup task when a predetermined switching trigger condition and/or predetermined switching trigger time is satisfied.

As an example, the predetermined switching trigger condition includes at least one of a notification message trigger, a network resource threshold trigger, a geographical location trigger, and a timing trigger.

For example, the notification message trigger is to trigger the switching through a notification message, the network resource threshold trigger is to trigger the switching when a network resource reaches a threshold, the geographical location trigger is to trigger the switching when a predetermined geographical location is reached, and the timing trigger is to trigger the switching when a predetermined timing is reached.

As an example, the predetermined switching trigger time includes pre-switching of performing switching before the target task being unable to be performed or post-switching of performing switching after the target task being unable to be performed.

As an example, the backup task includes sub-backup tasks respectively corresponding to sub-target tasks in the target task.

As an example, the determination unit 101 may be configured to perform resource allocation for each sub-target task and a sub-backup task corresponding to the sub-target task. Thus, a certainty of the task update switching and an orderliness of pre-allocation of network communication resources can be enhanced.

The resource allocation may, for example, reserve the least resource required for each task segment.

Hereinafter, for convenience, a sub-target task is sometimes referred to as a normal task, and a task segment is sometimes referred to as a task section.

For example, the resource pre-allocation performed by the electronic apparatus 100 includes: generating a task ID to uniquely identify a task requested by the UE within the network (where the task ID corresponds to a record of network resources used by the UE from the beginning to the end of the task, to facilitate charging after the service process is completed), pre-applying for resources from a base station associated with the service, and pre-configuring the task on an auxiliary communication device (RIS, vehicle relay, and the like) associated with the task (that is, reserving a specific spectrum resource in a certain time period for a specific base station).

FIG. 2 is a schematic diagram illustrating resource allocation according to an embodiment of the present disclosure. For simplicity, in FIG. 2, it is assumed that: during a first task segment from time point T0 to time point T1, a work mode corresponding to a sub-target task is autonomous navigation (marked as Autopilot L4 in the figure), and a work mode corresponding to a sub-backup task is autonomous navigation (marked as Autopilot L2 in the figure); during a second task segment from time point T2 to time point T3, a work mode corresponding to a sub-target task is autonomous navigation (marked as Autopilot L3 in the figure), and a work mode corresponding to a sub-backup task is remote driving (marked as Remote driving in the figure); and during a third task segment after time point T3, a work mode corresponding to a sub-target task is formation driving (marked as Platooning in the figure), and a work mode corresponding to a sub-backup task is an advanced driving assistance system (marked as ADAS in the figure).

As an example, the determination unit 101 may be configured to: reserve resources for performing all sub-backup tasks; and at each time point of being going to enter each task segment, book a resource for performing a sub-target task corresponding to the task segment.

For example, when a task is determined, resources (occupied resources) required for sub-backup task content in each task segment of the task are reserved in advance, and resources required for the (normal) task content in the first task segment are confirmed. Afterwards, resources required for (normal) task content of the next period is confirmed when being going to enter a next task segment (assuming triggered at a certain time point).

Combined with FIG. 2, the UE books and uses a resource required for a sub-target task in the first task segment at the task start time point TO, and books resources required for sub-backup tasks corresponding to all task segments in advance. After a period of time, when in the first task segment and is about to enter the second task segment (T1), book of a resource required for a sub-target task in the second task segment is triggered, and when entering the second task segment (T2), the resource required for the sub-target task in the first task segment and the resource required for the sub-backup task in the first task segment may be released. When in the second task segment and is about to enter the third task segment (T3), book of a resource required for a sub-target task in the third task segment is triggered. The rest may be performed in a similar manner.

As an example, the determination unit 101 may be configured to: at a time point of being going to enter an earliest task segment which is the earliest in time, book a resource for performing a sub-target task corresponding to the earliest task segment, and reserve resources for performing a sub-backup task corresponding to the earliest task segment and a sub-backup task corresponding to a next task segment; and at a time point of being going to enter each task segment other than the earliest task segment, book a resource for performing a sub-target task corresponding to the task segment, and reserve a resource for performing a sub-backup task corresponding to a next task segment.

Combined with FIG. 2, the UE books and uses a resource required for a sub-target task in the first task segment at the task start time point TO, and books resources required for sub-backup tasks corresponding to the first task segment and the second task segment in advance. After a period of time, when in the first task segment and is about to enter the second task segment (T1), book of a resource required for a sub-target task in the second task segment is triggered, and a resource required for a sub-backup task in the third task segment is reserved. When in the second task segment and is about to enter the third task segment (T3), book of a resource required for a sub-target task in the third task segment is triggered, and a resource required for a sub-backup task in the fourth task segment is reserved. The rest may be performed in a similar manner.

As an example, the determination unit 101 may be configured to: at time point of being going to enter each task segment, book a resource for performing a sub-target task corresponding to the task segment, and reserve a resource for performing a sub-backup task corresponding to the task segment.

Combined with FIG. 2, the UE books and uses a resource required for a sub-target task in the first task segment at the task start time point TO, and books a resource required for a sub-backup task in the first task segment. After a period of time, when in the first task segment and is about to enter the second task segment (T1), book of a resource required for a sub-target task in the second task segment and a resource required for a sub-backup task in the second task segment is triggered. When in the second task segment and is about to enter the third task segment (T3), book of a resource required for a sub-target task in the third task segment and a resource required for a sub-backup task in the third task segment is trigger. The rest may be performed in a similar manner.

For example, a priority of reservation of the resources corresponding to the sub-backup tasks is higher than a priority of reservation of the sub-target tasks, to ensure task continuity in case of exception occurrence.

As an example, the determination unit 101 may be configured to: after the user equipment enters a next task segment from a sub-target task in a current task segment, release a resource booked for performing a sub-target task corresponding to the task segment and release a resource reserved for performing a sub-backup task corresponding to the task segment.

As an example, the backup task is restored to the target task when a predetermined restoration condition is satisfied.

Those skilled in the art can understand that the predetermined restoration condition may be set based on experience or an application scenario.

The user equipment obtains the task content and task ID determined by the electronic apparatus 100, and executes the selected task content.

As an example, the determination unit 101 may be configured to determine a sub-work mode corresponding to the task segment according to geographical location information corresponding to the task segment.

An example description of switching among the remote driving, the autonomous driving, and the formation driving is provided below.

Examples of various services involved in C-V2X are provided here. A vehicle UE relies on a connection capability of the Internet of Vehicles and capabilities of autonomous driving/assisted driving and the like of the vehicle UE, to carry out different services (or work modes) on specific roads, such as formation driving, autonomous driving, assisted driving, and remote driving. The vehicle UE sets a task goal as traveling from location X to location Y. After mutual negotiation and confirmation between the UE and the network-side device, a route from location X to location Y is determined and is divided into three task segments, i.e., a road section A (from location A to a highway entrance a), a road section B (from the highway entrance a to a highway exit b), and a road section C (from the highway exit b to location Y). The road section A and the road section C are within a scope of urban roads, where the road environment (road conditions, roadside infrastructure, communication environment, and the like) can support high-level autonomous driving (which is a sub-target task content in this task segment) and assisted driving (which is a sub-backup task content). The urban road environment focuses on supporting services based on a PC5 interface. There are a large amount of urban mobile broadband (MBB) services and vehicles, and therefore it is not practical to set aside a large amount of Uu interface communications for vehicle applications. Therefore, it is necessary to deploy a large number of RSUs to provide sensor information sharing, vehicle identification information, lane planning information and other services based on PC5 interface broadcast, to support services of the (low speed) autonomous driving and assisted driving. The road section B is a high-speed road, on which a travel target of a vehicle usually does not change and a formation driving at a high speed has a good energy-saving effect. A road environment (road conditions, roadside infrastructure, communication environment, and the like) can support formation driving (which is a sub-target task content) and remote driving or RSU-assisted safe mode driving (which is a sub-backup task content). A road environment in the suburbs can support services based on the Uu interface. The population and vehicle density in the suburban environment are low and the roads are single. There is a possibility that the Uu interface is used as a V2X slice to flow out a large amount of communication resources to support vehicle services. The PC5 interface may perform communication modes such as multicast and unicast to support formation driving.

When the vehicle UE performs autonomous driving on the road section A, the vehicle UE obtains application layer services with a broadband, low latency and low packet loss rate QoS requirement provided by the RSU through the PC5 interface, such as high-resolution sensor real-time data (sensor fusion) and computing resources having a high computing power on the roadside (sensor fusion). The road segment A itself reserves related resources of base stations (responsible for allocating communication resources of the Uu and PC5), RSUs, MECs and other facilities along the way for the vehicle UE. It is possible that an emergency (such as a car accident ahead, traffic jams, traffic control, etc.) occurs at a certain intersection, and relevant resources at the intersection cannot be retained (need to be used to handle the emergency). In this case, the vehicle UE needs to switch to assisted driving. The PC5 interface supports a shared sensing data service (cooperative sensing) and the vehicle UE temporarily switches to an assisted driving mode. After driving through the intersection area, (relevant resources are restored satisfy the need of autonomous driving), the network-side device triggers the vehicle UE to return to the autonomous driving. Similarly, in the road section B, the vehicle UE, while in a service of formation driving normally, sends vehicle motion control data and shares sensor data between vehicles based on the multicasting of the PC5 interface. When encountering an emergency (such as a large truck inserting into the formation and blocking the multicast communication), some vehicles in the formation (for example, the vehicle UE being blocked) may be triggered to switch to remote driving (the remote driving needs to rely on Uu interface communications with a very good QoS status). In a case of a more extreme unexpected situation (such as the vehicle UE sidesliping and other out-of-control states), the vehicle UE needs to trigger a safety mode to escape from trouble and run to a safe area (emergency lane or deceleration slope), with assistance of a roadside RSU or network-side safety operation and control platform.

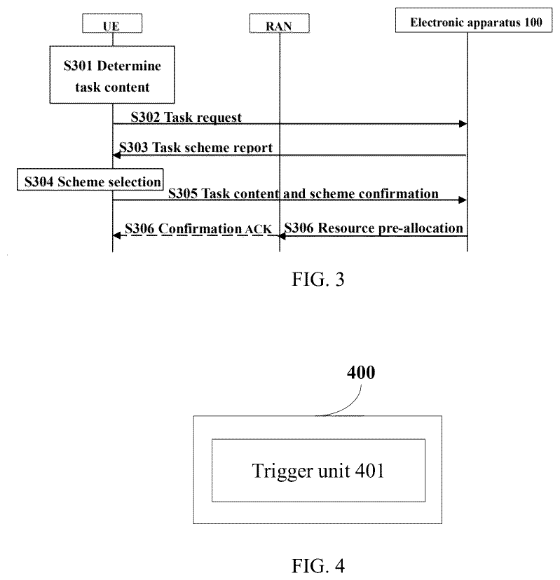

FIG. 3 is a schematic flow chart illustrating a process of confirming a task between an electronic apparatus 100 and user equipment (UE) according to an embodiment of the present disclosure.

In S301, the UE confirms content of a target task to be initiated (referred to as a task). In S302, the electronic apparatus 100 receives a task request sent by the UE. In S303, the electronic apparatus 100 determines a task scheme (for example, including a target task and a backup task) for the UE, and sends a task scheme report to the UE. In S304, the UE selects a task scheme suitable for tire blowout. In S305, the electronic apparatus 100 receives task content and scheme confirmation sent by the UE. In S306, the electronic apparatus performs resource pre-allocation for the task and sends a confirmation ACK to the UE via a radio access network (RAN).

For example, the other terminal involved in the task segment reports exception of a specific terminal task; and a network function entity triggers activation of a backup subtask content.

In most cases, the UE travels or performs a task according to the determined task content, but remotely manipulated machines such as a vehicle and UAV usually have a high degree of mobility and task flexibility. The high degree of mobility dynamically affects a device load and a network status of an area where the UE belongs in real time. Hence, the following situations may trigger switching of a remotely manipulated service.

In a case where an application layer is disabled or an application cannot sustain a current task, the UE needs to switch to a backup task in advance or quickly. Specifically, based on service data collected by the base station or application server and real-time QoS report information, a NWDAF on the network side or a self-test analysis function of the UE itself determines situations such as an abnormality (including large fluctuation, suspension, and the like) of an uplink and downlink data flow rate of the UE in a task segment, and an abnormality or error of the transport layer protocol (for example, the TCP/IP fails to receive an ACK/NACK).

Due to changes in a network status and service auxiliary facility (load) status corresponding to the area to which the UE currently belongs, it is necessary to change the service content of the UE. For example, there are shortages in slice resources allocated by the core network or base station for a V2X service, V2X/UAV dedicated spectrum resources, an upper limit of the number of UEs that a current RSU can serve, and a service area/number restriction of sensing devices. Specifically, within a task segment, abnormalities in computing resources and sensing resources may include non-usage of resources for a period of time, interference/accuracy (confidence) decrease of a sensing capability, temporary occupancy of resources by other services, and the like.

An electronic apparatus for wireless communications is further provided according to another embodiment of the present disclosure. FIG. 4 shows a block diagram of functional modules of an electronic apparatus 400 for wireless communications according to another embodiment of the present disclosure.

As shown in FIG. 4, the electronic apparatus 400 includes a trigger unit 401. The trigger unit 401 may be configured to trigger a request for processing a protocol data unit. PDU session when user equipment located within a service range of the electronic apparatus 400 is to switch from a current task to a to-be-switched task, where a first QoS flow in a first PDU session corresponding to the current task is related to a second QoS flow in a second PDU session corresponding to the to-be-switched task.

The trigger unit 401 may be implemented by one or more processing circuits. The processing circuitry may be implemented as a chip, for example.

The electronic apparatus 400 may serve as a network-side device in a wireless communication system.

The electronic apparatus 400 may, for example, be provided on a base station side or be communicatively connected to a base station. Here, it should be noted that the electronic apparatus 400 may be implemented at a chip level or at an apparatus level. For example, the electronic apparatus 400 may operate as the base station itself and may further include a memory, a transceiver (not shown), and other external devices. The memory may store related data information and programs that the base station needs to execute to achieve various functions. The transceiver may include one or more communication interfaces to support communications with different devices (such as user equipment (UE), another base station, and the like). An implementation of the transceiver is not specifically limited here. The base station may be an eNB or gNB, as an example. The electronic apparatus 400 may be a core network.

The wireless communication system according to the present disclosure may be a 4G NR (New Radio) communication system. Further, the wireless communication system according to the present disclosure may include a non-terrestrial network (NTN). Alternatively, the wireless communication system according to the present disclosure may further include a terrestrial network (TN). In addition, those skilled in the art can understand that the wireless communication system according to the present disclosure may be a 4G or 3G communication system.

For example, the switching is triggered implicitly according to a switching condition which is negotiated between the UE and the electronic apparatus 400 before the switching, for example, when a time point, a geographical location, a certain network parameter (QoS quality) or a parameter of a certain resource is detected reaching a threshold. This method is suitable for handling an abnormal UE function.

In addition, for example, the UE determines that it is necessary to trigger the switching based on a functional status of the UE and a task execution status, and sends a task switching request message to the electronic apparatus 400 (for example, the message is a NAS message if the message is sent to a core network, and the request message is carried by a RRC message if the message is sent to a base station). For example, the UE sends a new NAS message as a task switching request to the core network, and indicates that a switching reason is function failure, resource shortage, or the like.

For example, a task switching process in a communication segment mainly involves a PDU session/QOS establishment/modification/release process. Since switching of task content of the manipulated machine (such as switching from remote driving to autonomous driving) is involved, there is actually a period of time in which two tasks exist simultaneously.

In a case where the task switching does not involve a third-party terminal/application server and other equipment (for example, the task switching is limited to one UE and the electronic apparatus 400), only change and switching of one or more QoS flow parameters within the UE (contained in one or more PDU sessions) is involved. In a case where two QoS flows are involved and are in a substitution relationship, the first Qos flow in the first PDU session corresponding to a current task is related to the second QoS flow in the second PDU session corresponding to the to-be-switched task.

In the electronic apparatus 400 according to the embodiment of the present disclosure, the first QoS flow in the first PDU session corresponding to the current task is related to the second QoS flow in the second PDU session corresponding to the to-be-switched task, so that situations of a long time required to switch QoS or a high probability of process failure are avoided. For example, situations of a long time required to switch QoS or a high probability of process failure in an emergency state can be avoided.

As an example, the request includes a modification request for the first PDU session (PDU Session Modification Request), and the modification request for the first PDU session triggers modification of the first Qos flow, and triggers a modification request for the second PDU session or an establishment request for the second PDU session.

As an example, the modification request for the second PDU session triggers modification of the second PDU session and/or the second Qos flow.

As an example, the establishment request for the second PDU session (PDU Session Establishment Request) triggers establishment of the second PDU session and the second Qos flow.

As an example, the request includes a release request for the first PDU session (PDU Session Release Request), and the release request for the first PDU session triggers release of the first Qos flow, and triggers an establishment request for the second PDU session.

As an example, the establishment request for the second PDU session triggers establishment of the second PDU session and the second Qos flow.

For example, in order to realize the correlation between the Qos flows, an information element is newly added to an existing signaling (such as a PDU session modification request or a PDU session establishment request), to carry a PDU session identifier (PDU session ID) that is triggered to be established, modified, and released, and a description of an affected QoS flow (a QoS flow identifier (QFI) and a corresponding processing method, a parameter that needs to be deleted or modified, and the like).

As an example, an information element is added to the modification request for the first PDU session, and the information element includes an identifier of the second PDU session and information about the second Qos flow.

As an example, an information element is added to the release request for the first PDU session, and the information element includes an identifier of the second PDU session and information about the second Qos flow.

As an example, the information about the second Qos flow includes an ID of the second Qos flow, and a to-be-processed parameter of the second Qos flow. For example, the to-be-processed parameter includes a parameter that need to be deleted or modified, or the like.

As an example, the current task and the to-be-switched task belong to a target task, and the target task is performed according to a corresponding work mode.

As an example, the user equipment may be a vehicle operated and/or driven remotely. The work mode may include one of single-vehicle autonomous driving, formation driving, autonomous driving, remote monitoring, direct remote control, indirect remote control, and manual manipulation. For example, the target task may include: (one or more) travel destinations, expected arrival time, supported travel control modes (single-vehicle autonomous driving, formation driving, autonomous driving and remote monitoring, direct remote control, indirect remote control, and manual manipulation) and network requirements of the travel modes (communication QoS requirements, roadside unit sensing requirements, and network computing power requirements), a cruising range and charging requirement, and an impact of an energy-saving mode on the above parameters, and the like.

As an example, the user equipment may be an unmanned aerial vehicle (UAV). The work mode may include one of autonomous driving, formation driving, remote monitoring, direct remote control, indirect remote control, and manual manipulation. For example, target tasks may include: a flight cruising speed (considering that UAV of a fixed-wing type can reach a speed of more than 300 km/h), supported control types (autonomous driving, formation driving, remote monitoring, direct remote control, non-direct remote control, and manual manipulation), a flight duration limit, a flight target area (altitude, longitude and latitude range).

As an example, the user equipment may be mechanical equipment, such as a robot. For example, the target tasks may include a work target area, and a work requirement for communication QoS. The works may include works of a remotely driven vehicle or UAV (such as loading and unloading cargo, spraying pesticides, environmental monitoring, and the like), or works of special equipment (such as, control of a forklift, control of a gantry or crane, and the like).

In addition to the above examples, those skilled in the art may envisage other examples of the user equipment and the work mode, which are not described in detail here.

As an example, the target task may be divided into one or more task segments in time. In each task segment, a sub-target task included in the target task and corresponding to the task segment is performed. The sub-target task is performed according to a corresponding sub-work mode included in the work mode for performing the target task.

As an example, the trigger unit 401 may be configured to detect, for at least one task segment of the one or more task segments, exception information related to execution of a sub-target task within the task segment, to detect an abnormality in the user equipment.

As an example, the exception information includes an abnormality of a data flow rate of the user equipment within the task segment.

As an example, the exception information may include an abnormality of computing resources and/or abnormality of sensing resources of the user equipment within the task segment, and the abnormality of sensing resources includes one of the following: non-usage of the resources within a predetermined period of time, interference on a sensing capability, or decrease of accuracy of the sensing capability.

As an example, the exception information may include information about an abnormality of the user equipment reported within the task segment by an apparatus for performing the sub-target task.

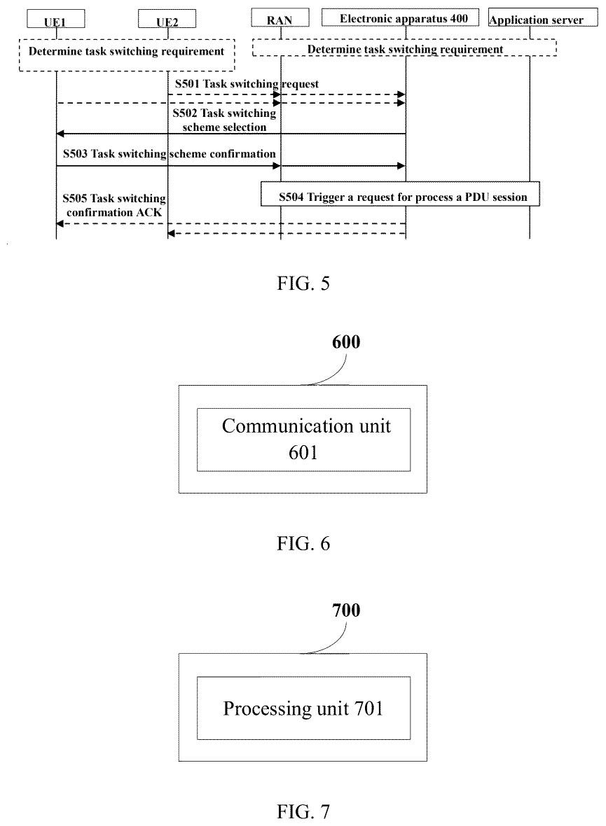

FIG. 5 is a flow chart illustrating a process of task switching according to an embodiment of the present disclosure.

In FIG. 5, as an example, two UEs (UE1 and UE2), a RAN, an electronic apparatus 400 and an application server are shown.

First, the UE1 and the UE2 determine a task switching requirement, and the RAN, the electronic apparatus 400 and the application server determine the task switching requirement.

In S501, the electronic apparatus 400 accepts task switching requests from the UE1 and the UE2 respectively via the RAN.

Hereinafter, the UE1 and UE2 are sometimes collectively referred to as UE, for convenience.

In a case where the task switching is triggered by the UE actively, according to a current new task content (for example, a destination, a route, an operating mode, a cruising speed, a special task, and switching of an energy-saving mode), the UE indicate the electronic apparatus 400 the following situation: active change of the vehicle/UAV based on human subjective preference, change due to the vehicle/UAV detecting change in a road environment/weather condition (such as a car accident, congestion, heavy wind, rain, snow, and the like), and change of service content of a certain UE applied by a law enforcement/management vehicle, RSU equipment, and the like (trigger by a third-party UE) and other situations. There is a situation where a backup task scheme is triggered actively, including failover of a particular function of a current service of the UE, the computing power service and sensing service actually provided by a UE-side application layer being insufficient to support the current application service, and the like. In such situations, signaling may also be sent to instruct the electronic apparatus 400 to switch the backup task scheme.

For a situation where the task switching is trigger by a third-party UE, a law enforcement/management vehicle may change a task of one UE or multiple UEs based on road conditions, regulations, overall task scheduling and other conditions. For example, terminals of traffic police control and a road rescue department apply for an artificial change on a certain illegal terminal (similar to an emergency service), and a formation master UE requests to change a task of a member UE in the formation, a construction site/mine/port console terminal requests to change a task of a terminal controlled in the field, and the like. The third-party UE needs to indicate a UE ID and a task ID of the managed UE to the electronic apparatus 400 (another feasible way is that the third-party management terminal instructs the controlled UE or network-side device through an application server or application layer, and then the controlled UE or the electronic apparatus 400 triggers the task switching).

Additionally, the UE may further indicate to the electronic apparatus 400 a switching priority (a priority of a task switching processing, an importance of the switched task), a time range for the task switching, a geographical location range of the switching, a parameter threshold range for triggering the switching, and a switching manner (changing a parameter of a current service flow, switching a service flow, changing an object of a service flow, and the like). Changing an object of a service flow may include: for example, an RSU/edge computing unit applying to take over a certain remote driving/autonomous driving vehicle, which involves a certain QoS flow (such as sensor data) being switched from a UE (such as a remote driving console) to another UE (such as the RSU).

In S502, the electronic apparatus 400 sends a task switching scheme to the UE for selection by the UE.

In a case where the UE requests change and switching of a task of the UE, the task switching scheme includes re-negotiation of a task and activation of a pre-configured scheme and resource.

In a case where a third-party terminal requests a service change and switching for the UE, the third-party terminal needs to verify its management identity and management authority with the electronic apparatus 400. The third-party terminal needs to indicate a parameter such as a task ID (an encrypted parameter between a managed terminal and the electronic apparatus 400). Alternatively, the managed terminal indicates a UE ID of its management terminal (such as a SUPI) when the task is initiated; or the management terminal itself indicates, when accessing the network, to the electronic apparatus 400 an identity such as a V2X service administrator of the management terminal (the identity is indicated through an authentication server, a security certificate server, or the like).

In a case where the change and switching is triggered by the electronic apparatus 400, the electronic apparatus 400 determines that it cannot continue to maintain the existing service QoS or the original set resource reservation for the UE, based on a real-time updated communication network resource, a roadside computing resource, a roadside sensing resource, an application server resource and other parameters (That is, the original task content cannot be maintained. The present disclosure is more inclined to that the pre-configured task content and the resource reservation cannot be guaranteed, and therefore determines an updated solution in advance, rather than triggering a service switching when QoS cannot be guaranteed as in a conventional technology). That is, for service content with important safety production risks, a risk of being unable to guarantee the QoS and thus unable to guarantee a task quality needs to be eliminated in advance.

In a case where the task scheme that currently needs to be switched has a backup task scheme, the electronic apparatus 400 selects a scheme according to a switching trigger condition (self-trigger or by a UE request). If there are multiple sets of backup schemes, a scheme is selected as indicated under an instruction of the UE, or under indication by the network based on a current resource load/reservation situation and a preference of the UE in a service determination process (for example, whether to continue to complete the target, whether to return to an original task, or a preference priority of the service type (for example, a user preferably prioritizes the formation traveling, then the manual driving and the emergency side parking, and the like)). Specifically, when switching tasks, the following mechanisms may exist.

a) A transmission service of relevant service data before and after the switching is carried by the Uu interface, the electronic apparatus 400 triggers the backup task content according to the switching triggering condition (notification message trigger, threshold value trigger, immediate trigger or scheduled fixed-point trigger), a switching time requirement (pre-switching, switching after occurrence) and other pre-configured parameters.

b) All resource services before the switching are carried by communication of the Uu interface, and transmission of relevant service data after the switching is carried by the PC5 interface. In this case, the network-side device needs to notify (perform signaling interaction) resource reservation units (such as an RSU, a relay node, and a PC5-based edge computing unit) having a PC5 capability, and the resource reservation unit having the PC5 capability of the relevant PC5 is triggered to broadcast the business service (in order to be discovered by a terminal and establish the service).

In a case where there is no backup task scheme, based on a network status, operating environment (road conditions, weather environment, roadside facilities, site and other factors), the service type and service level supported by the UE, the current remaining mileage and other factors, the electronic apparatus 400 determines task content (scheme list) that can currently be switched to for the designated UE, a scheme of the UE task switching (a time interval and geographical location range of the switching task), and a priority of the switching task (a switching sequence is mainly determined based on the importance of the service).

The electronic apparatus 400 instructs a specific terminal to update the above-mentioned switching content, and indicates a trigger type of service content switching:
a) trigger by a UE request;
b) trigger by management and intervention of a third-party, a UE ID of a third-party management terminal and a specific trigger reason (for example, government policy control such as temporary road management and airspace control, change in a service goal/demand, queue-jumping in a formation, a factory accident or other emergencies) and other parameters;
c) trigger by the electronic apparatus 400, a specific trigger reasons of the electronic apparatus 400 (a QoS prediction, a limitation of network resources, indirect triggering by a third party, and the like) and other parameters.

In S503, the electronic apparatus 400 receives a task switching scheme confirmation from the UE.

After receiving the task switching scheme indicated by the electronic apparatus 400, the UE determines an acceptable task switching scheme (including a list of priorities of switchable schemes, task content after switching, a switching manner, and the like), and indicates the acceptable task switching scheme to the network-side device through signaling.

The switching content includes: a triggering method of the switching (time trigger, geographical location trigger, network resource threshold trigger, and the like), an initiator that triggers the switching (the UE, a third-party UE, or the network-side device), a QoS flow and a PDU session parameter involved in the service switching, and the like. The time trigger is that the UE or electronic apparatus 400 starts a timer after confirmation by both parties, and triggers a service change and switching process when the timer stops/expires. For the geographical location trigger, a geographical location of the UE is obtained by the UE based on its own GNSS signal or by a base station/core network functional entity through a 3GPP measurement sensing method, and the service change and switching process is triggered when the UE enters a specific area (such as a cell, a zone, and an electronic fence). The network resource threshold trigger may be to trigger the service change and switching process when a certain network parameter (such as PDB or PER or similar communication QoS parameters, and size of the remaining allocable spectrum of the base station) reaches a certain threshold.

For situations triggered by a third party, the UE may choose to verify the permissions of a third-party terminal or third-party application server, and may reject the request for changing relevant service content based on the situation (such as authentication failure, switched services not supported, and the like) (whether the rejection successes depends on local regulations and operator policies).

One possibility is that after the terminal selects a scheme, the terminal directly determines to trigger by itself, without requiring the network side or a third-party UE to participate in the triggering process and scheduling (the remaining steps S504 and S505 may be omitted).

In S504, a request for processing a PDU session is triggered.

As mentioned above, in a case where the task switching does not involve a third-party terminal/application server and other equipment (the switching is limited to one UE and the electronic apparatus 400), only change and switching of one or more QoS flow parameters within the UE (contained in one or more PDU sessions) is involved.

In a case where the task switching involves a third-party terminal/application server equipment, intervention of the third-party terminal/application server inevitably brings about signaling between multiple UEs/networks to indicate a triggering relationship/sequence of multi-QoS flow processes (for example, indicating preparation of a new service explicitly through signaling between UEs or signaling between UE and another UE indirectly through the network; implicitly triggering release/modification of another QoS by setting a timer after establishment/modification of a certain QoS flow; and the like).

Regardless of whether the task switching involves a third-party terminal/application server, the switching brings a short-term data burst to the base station side, and similar switching requirements in a same area and time domain are likely to be triggered collectively. In this case, when the core network and base station on the network side determine the switching action, multiple switching tasks in a certain area (such as a certain zone, a certain beam direction) are scheduled to be staggered in the time domain (for example, a SMF or gNB decides a time sequence of the switching tasks and indicates to the other party). A possible implementation is that the SMF determines multiple PDU session modification processes that may affect each other and informs the base station gNB (including a PDU ID of the PDU session, a UE ID to which it belongs, and a priority of the switching), the gNB determines a switching sequence based on location information of the UEs and the priority of the switching.

In S505, after confirming specific parameters such as a trigger relationship and a trigger sequence in S504, the electronic apparatus 400 sends a final task switching confirmation ACK to a UE terminal or third-party UE according to a switching object range. After receiving the confirmation, the UE starts a relevant timer, monitors the geographical location area trigger condition, the network parameter trigger condition parameter, and the like.

It should be noted that S505 is not required in a case where all triggering actions occur on the side of the electronic apparatus 400 side.

An electronic apparatus for wireless communications is further provided according to a further embodiment of the present disclosure. FIG. 6 shows a block diagram of functional modules of an electronic apparatus 600 for wireless communications according to a further embodiment of the present disclosure.

As shown in FIG. 6, the electronic apparatus 600 includes a communication unit 601. The communication unit 601 may be configured to send a task request to a network-side device serving the electronic apparatus 600, for the network-side device to determine at least one target task to be initiated for the electronic apparatus 600, where each target task is performed according to a corresponding work mode, and the task request includes a task list having the at least one target task and a list indicating a priority of the work mode.

The communication unit 601 may be implemented by one or more processing circuits. The processing circuitry may be implemented as a chip, for example.

The electronic apparatus 600 may, for example, be provided on a user equipment (UE) side or be communicatively connected to the user equipment. In a case where the electronic apparatus 600 is provided on the user equipment side or communicatively connected to the user equipment, the electronic apparatus 600 may be user equipment. Here, it should be noted that the electronic apparatus 600 may be implemented at a chip level or at an apparatus level. For example, the electronic apparatus 600 may operate as the user equipment itself and may further include a memory, a transceiver (not shown), and other external devices.

The memory may store related data information and programs that the user equipment needs to execute to achieve various functions. The transceiver may include one or more communication interfaces to support communications with different devices (such as a base station, another UE, and the like). An implementation of the transceiver is not specifically limited here.

As an example, the network-side device may be the electronic apparatus 100 mentioned above. As an example, the electronic apparatus 600 may be the user equipment involved in the above embodiment of the electronic apparatus 100.

The wireless communication system according to the present disclosure may be a 5G NR communication system. Further, the wireless communication system according to the present disclosure may include a non-terrestrial network. Alternatively, the wireless communication system according to the present disclosure may further include a terrestrial network. In addition, those skilled in the art can understand that the wireless communication system according to the present disclosure may be a 4G or 3G communication system.

In an embodiment according to the present disclosure, the electronic apparatus 600 may send the task request to the network-side device for determining the target task for the electronic apparatus 600, so that an applicability of determining the target task is improved.

The target task includes a mobility target task in which the electronic apparatus 600 reaches a predetermined geographical location and/or a motionless target task in which the electronic apparatus 600 works within a predetermined area.

As an example, the predetermined geographical location includes one or more geographical locations arranged sequentially and/or by priority.

As an example, the electronic apparatus 600 may be a vehicle operated and/or driven remotely. The work mode may include one of single-vehicle autonomous driving, formation driving, autonomous driving, remote monitoring, direct remote control, indirect remote control, and manual manipulation. For example, the target task may include: (one or more) travel destinations, expected arrival time, supported travel control modes (single-vehicle autonomous driving, formation driving, autonomous driving and remote monitoring, direct remote control, indirect remote control, and manual manipulation) and network requirements of the travel modes (communication QoS requirements, roadside unit sensing requirements, and network computing power requirements), a cruising range and charging requirement, and an impact of an energy-saving mode on the above parameters, and the like.

As an example, the electronic device 600 may be an unmanned aerial vehicle (UAV). The work mode may include one of autonomous driving, formation driving, remote monitoring, direct remote control, indirect remote control, and manual manipulation. For example, target tasks may include: a flight cruising speed (considering that UAV of a fixed-wing type can reach a speed of more than 300 km/h), control types (autonomous driving, formation driving, remote monitoring, direct remote control, non-direct remote control, and manual manipulation), a flight duration limit, a flight target area (altitude, longitude and latitude range).

As an example, the electronic apparatus 600 may be mechanical equipment, such as a robot. For example, the target tasks may include a work target area, and a work requirement for communication QoS. The works may include works of a remotely driven vehicle or UAV (such as loading and unloading cargo, spraying pesticides, environmental monitoring, and the like), or works of special equipment (such as, control of a forklift, control of a gantry or crane, and the like).

In addition to the above examples, those skilled in the art may envisage other examples of the electronic apparatus 600 and the work mode, which are not described in detail here.

As an example, each target task is divided into one or more task segments according to time and/or geographic area. In each task segment, a sub-target task included in the target task and corresponding to the task segment is performed. The sub-target task is performed according to a corresponding sub-work mode included in the work mode for performing the target task. Therefore, by dividing the target task into sub-target tasks, the target task has a new granularity of a life cycle and can be composed of switching among multiple sub-target task.

For example, the target task is divided into multiple sub-target tasks based on a current service map (a network status and service status corresponding to each area).

As an example, in each task segment, a sub-target task corresponding to the task segment is suspended or switched if any sub-work mode is interrupted.

As an example, the target task is determined by the network-side device based on resources managed by the network-side device.

As an example, the resources managed include at least one of network communication resources, computing power resources, sensing capability resources, and work collaboration resources corresponding to the work mode.

As an example, the network communication resources include at least one of: a frequency band bandwidth resource of a Uu interface, a signal reflection resource of a reconfigurable intelligence surface, a relay capability resource of relay user equipment, and a contiguous PC5 coverage resources within the task segment.

As an example, the work collaboration resources include capability resources of other entities different from the electronic apparatus 600 and the network-side device required for performing the target task. For example, other entities may be component members for assisting positioning, formation, or the like.

As an example, the network-side device determines a sub-work mode corresponding to the task segment according to geographical location information corresponding to the task segment.

For relevant examples, reference may be made to the description in conjunction with FIG. 3 in the embodiments of the electronic apparatus 100, which is not repeated here.

As an example, the target task has a corresponding backup task, and the backup task is a task to be performed in place of the target task when the target task is unable to be performed.

As an example, the communication unit 601 may be configured to send a backup task request to the network-side device, for the network-side device to generate the backup task.

As an example, the backup task request includes information regarding whether the electronic apparatus 600 accepts to determine the backup task by the network-side device.

As an example, the backup task request further includes information regarding whether the electronic apparatus 600 continues performing the target task.

As an example, the backup task request further includes a redundancy requirement regarding the backup task.

As an example, the target task is switched to a corresponding backup task when a predetermined switching trigger condition and/or predetermined switching trigger time is satisfied.

As an example, the predetermined switching trigger condition includes at least one of a notification message trigger, a network resource threshold trigger, a geographical location trigger, and a timing trigger.

As an example, the predetermined switching trigger time includes pre-switching of performing switching before the target task being unable to be performed or post-switching of performing switching after the target task being unable to be performed.

As an example, the backup task includes sub-backup tasks respectively corresponding to sub-target tasks in the target task.

As an example, resources required to perform each sub-target task and a sub-backup task corresponding to the sub-target task are allocated by the network-side device.

As an example, the resources are allocated by the network-side device in the following manner: reserving resources for performing all sub-backup tasks, and at time point of being going to enter each task segment, booking a resource for performing a sub-target task corresponding to the task segment.

As an example, the resources are allocated by the network-side device in the following manner: at a time point of being going to enter an earliest task segment which is the earliest in time, booking a resource for performing a sub-target task corresponding to the earliest task segment, and reserving resources for performing a sub-backup task corresponding to the earliest task segment and a sub-backup task corresponding to a next task segment; and at a time point of being going to enter each task segment other than the earliest task segment, booking a resource for performing a sub-target task corresponding to the task segment, and reserving a resource for performing a sub-backup task corresponding to a next task segment.

As an example, the resources are allocated by the network-side device in the following manner: at each time point of being going to enter each task segment, booking a resource for performing a sub-target task corresponding to the task segment, and reserving a resource for performing a sub-backup task corresponding to the task segment.

For relevant examples of resource allocation, reference may be made to the description in conjunction with FIG. 2 in the embodiments of the electronic apparatus 100, which is not repeated here.

As an example, after the electronic apparatus 600 enters a next task segment from a sub-target task in a current task segment, the network-side device releases a resource booked for performing a sub-target task corresponding to the task segment and releases a resource reserved for performing a sub-backup task corresponding to the task segment.

As an example, the backup task is restored to the target task when a predetermined restoration condition is satisfied.

An electronic apparatus for wireless communications is further provided according to a further embodiment of the present disclosure. FIG. 7 shows a block diagram of functional modules of an electronic apparatus 700 for wireless communications according to a further embodiment of the present disclosure.

As shown in FIG. 7, the electronic apparatus 700 includes a processing unit 701. The processing unit 701 may be configured to cause, when the electronic apparatus 700 is to switch from a current task to a to-be-switched task, a network-side device serving the electronic apparatus 700 to trigger a request for processing a protocol data unit (PDU) session, where a first QoS flow in a first PDU session corresponding to the current task is related to a second QoS flow in a second PDU session corresponding to the to-be-switched task.

The processing unit 701 may be implemented by one or more processing circuits. The processing circuitry may be implemented as a chip, for example.

The electronic apparatus 700 may, for example, be provided on a user equipment (UE) side or be communicatively connected to the user equipment. In a case where the electronic apparatus 700 is provided on the user equipment side or communicatively connected to the user equipment, the electronic apparatus 700 may be user equipment. Here, it should be noted that the electronic apparatus 700 may be implemented at a chip level or at an apparatus level. For example, the electronic apparatus 700 may operate as the user equipment itself and may further include a memory, a transceiver (not shown), and other external devices. The memory may store related data information and programs that the user equipment needs to execute to achieve various functions. The transceiver may include one or more communication interfaces to support communications with different devices (such as a base station, another UE, and the like). An implementation of the transceiver is not specifically limited here.

As an example, the network-side device may be the electronic apparatus 400 mentioned above. As an example, the electronic apparatus 700 may be the user equipment involved in the above embodiment of the electronic apparatus 400.

In an embodiment of the present disclosure, the first QOS flow in the first PDU session corresponding to the current task is related to the second QoS flow in the second PDU session corresponding to the to-be-switched task, so that situations of a long time required to switch QoS or a high probability of process failure are avoided. For example, situations of a long time required to switch QoS or a high probability of process failure in an emergency state can be avoided.

As an example, the request includes a modification request for the first PDU session, and the modification request for the first PDU session triggers modification of the first Qos flow, and triggers a modification request for the second PDU session or an establishment request for the second PDU session.

As an example, the modification request for the second PDU session triggers modification of the second PDU session and/or the second Qos flow.

As an example, the establishment request for the second PDU session triggers establishment of the second PDU session and the second Qos flow.

As an example, the request includes a release request for the first PDU session, and the release request for the first PDU session triggers release of the first Qos flow, and triggers an establishment request for the second PDU session.

As an example, the establishment request for the second PDU session triggers establishment of the second PDU session and the second Qos flow.

As an example, an information element is added to the modification request for the first PDU session, and the information element includes an identifier of the second PDU session and information about the second Qos flow.

As an example, an information element is added to the release request for the first PDU session, and the information element includes an identifier of the second PDU session and information about the second Qos flow.

As an example, the information about the second Qos flow includes an ID of the second Qos flow, and a to-be-processed parameter of the second Qos flow.

As an example, the current task and the to-be-switched task belong to a target task, and the target task is performed according to a corresponding work mode.

As an example, the electronic apparatus 700 may be a vehicle operated and/or driven remotely. The work mode may include one of single-vehicle autonomous driving, formation driving, autonomous driving, remote monitoring, direct remote control, indirect remote control, and manual manipulation. For example, the target task may include: (one or more) travel destinations, expected arrival time, supported travel control modes (single-vehicle autonomous driving, formation driving, autonomous driving and remote monitoring, direct remote control, indirect remote control, and manual manipulation) and network requirements of the travel modes (communication QoS requirements, roadside unit sensing requirements, and network computing power requirements), a cruising range and charging requirement, and an impact of an energy-saving mode on the above parameters, and the like.

As an example, the electronic device 700 may be an unmanned aerial vehicle (UAV). The work mode may include one of autonomous driving, formation driving, remote monitoring, direct remote control, indirect remote control, and manual manipulation. For example, target tasks may include: a flight cruising speed (considering that UAV of a fixed-wing type can reach a speed of more than 300 km/h), control types (autonomous driving, formation driving, remote monitoring, direct remote control, non-direct remote control, and manual manipulation), a flight duration limit, a flight target area (altitude, longitude and latitude range).

As an example, the electronic apparatus 700 may be mechanical equipment, such as a robot. For example, the target tasks may include a work target area, and a work requirement for communication QoS. The works may include works of a remotely driven vehicle or UAV (such as loading and unloading cargo, spraying pesticides, environmental monitoring, and the like), or works of special equipment (such as, control of a forklift, control of a gantry or crane, and the like).

In addition to the above examples, those skilled in the art may envisage other examples of the electronic apparatus 700 and the work mode, which are not described in detail here.

As an example, the target task is divided into one or more task segments in time. In each task segment, a sub-target task included in the target task and corresponding to the task segment is performed. The sub-target task is performed according to a corresponding sub-work mode included in the work mode for performing the target task.

As an example, exception information related to execution of a sub-target task within at least one task segment of the one or more task segments is detected by the network-side device, to detect an abnormality in the electronic apparatus 700.

As an example, the exception information includes an abnormality of a data flow rate of the electronic apparatus 700 within the task segment.

As an example, the exception information includes an abnormality of computing resources and/or abnormality of sensing resources of the electronic apparatus 700 within the task segment, and the abnormality of sensing resources includes one of the following: non-usage of the resources within a predetermined period of time, interference on a sensing capability, or decrease of accuracy of the sensing capability.

As an example, the exception information may include information about an abnormality of the electronic apparatus 700 reported within the task segment by an apparatus for performing the sub-target task.

For relevant examples of resource allocation, reference may be made to the description in conjunction with FIG. 5 in the embodiments of the electronic apparatus 400, which is not repeated here.

In the description of the electronic apparatuses for wireless communications in the above embodiments, some processes or methods are further disclosed. Hereinafter, an overview of the methods is given without repeating some of details discussed above. It should be noted that although disclosed in the description of the electronic apparatuses for wireless communications, the methods do not necessarily adopt the components as described or be performed by those components. For example, an embodiment of the electronic apparatus for wireless communications may be implemented partially or entirely using hardware and/or firmware, while a method for wireless communications discussed below may be implemented entirely by a computer-executable program, although the method may employ the hardware and/or firmware for the electronic apparatus for wireless communications.

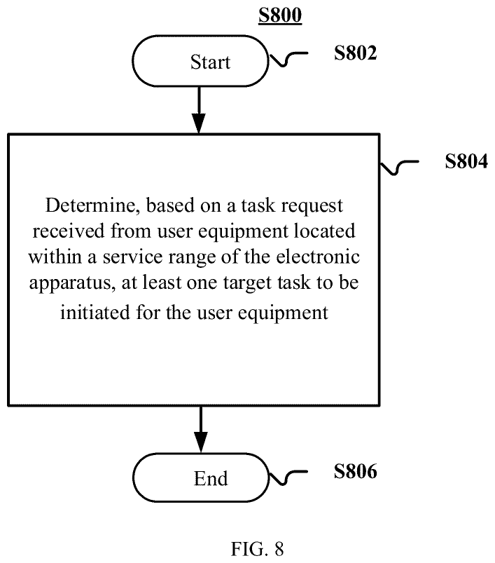

FIG. 8 shows a flow chart of a method S800 for wireless communications according to an embodiment of the present disclosure. The method S800 starts from step S802. In step S804, at least one target task to be initiated for user equipment is determined based on a task request received from the user equipment located within a service range of an electronic apparatus, where each target task is performed according to a corresponding work mode, and the task request includes a task list having the at least one target task and a list indicating a priority of the work mode. The method S800 ends at step S806.

This method may be performed, for example, by the electronic apparatus 100 as described above. For specific details, reference may be made to description at a corresponding section above, which is not repeated here.

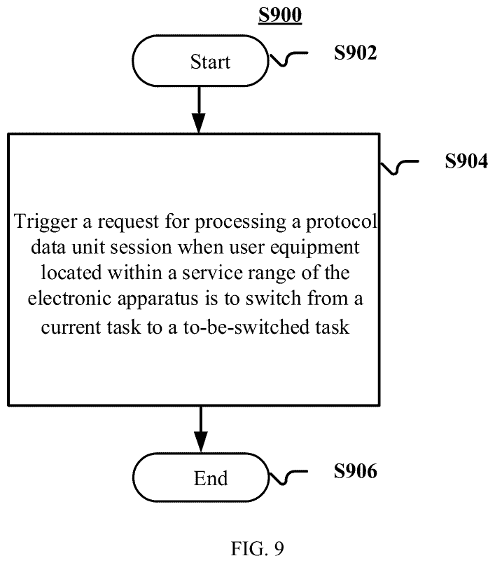

FIG. 9 shows a flow chart of a method S900 for wireless communications according to another embodiment of the present disclosure. The method S900 starts from step S902. In step S904, a request for processing a protocol data unit PDU session is triggered when user equipment located within a service range of an electronic apparatus is to switch from a current task to a to-be-switched task, where a first QoS flow in a first PDU session corresponding to the current task is related to a second QoS flow in a second PDU session corresponding to the to-be-switched task. The method S900 ends at step S906.

This method may be performed, for example, by the electronic apparatus 400 as described above. For specific details, reference may be made to description at a corresponding section above, which is not repeated here.

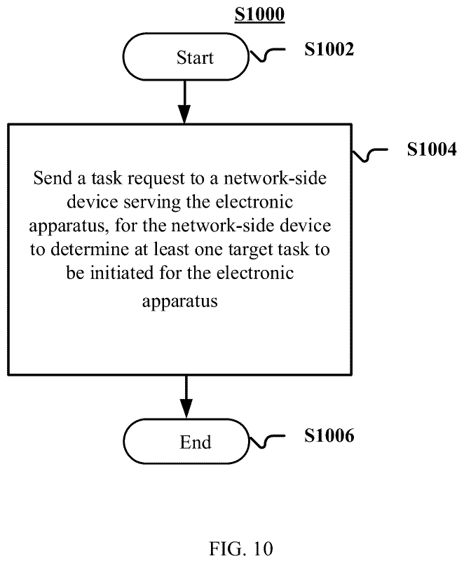

FIG. 10 shows a flow chart of a method S1000 for wireless communications according to an embodiment of the present disclosure. The method S1000 starts from step S1002. In step S1004, a task request is sent to a network-side device serving an electronic apparatus, for the network-side device to determine at least one target task to be initiated for the electronic apparatus, where each target task is performed according to a corresponding work mode, and the task request includes a task list having the at least one target task and a list indicating a priority of the work mode. The method S1000 ends at step S1006.

This method may be performed, for example, by the electronic apparatus 600 as described above. For specific details, reference may be made to description at a corresponding section above, which is not repeated here.

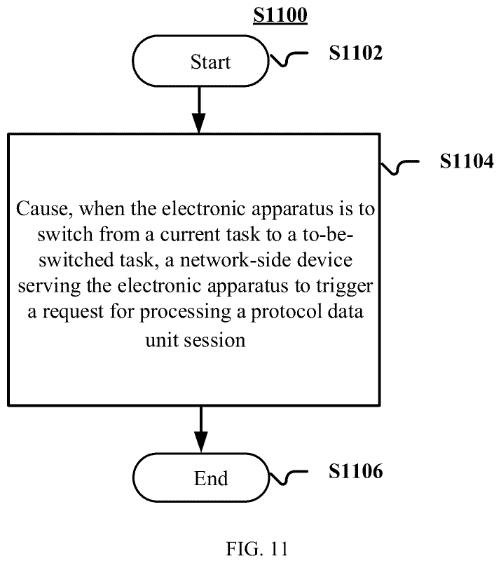

FIG. 11 shows a flow chart of a method S1100 for wireless communications according to an embodiment of the present disclosure. The method S1100 starts from step S1102. In step S1104, a network-side device serving an electronic apparatus is caused to trigger a request for processing a protocol data unit PDU session, when the electronic apparatus is to switch from a current task to a to-be-switched task, where a first QoS flow in a first PDU session corresponding to the current task is related to a second QoS flow in a second PDU session corresponding to the to-be-switched task. The method S1100 ends at step S1106.

This method may be performed, for example, by the electronic apparatus 700 as described above. For specific details, reference may be made to description at a corresponding section above, which is not repeated here.

The technology of the present disclosure can be applied to various products.

For example, the electronic apparatus 100 and 400 may be implemented as various network side apparatuses, such as a base station, an RAN, and an application server. The base station may be implemented as any type of evolved Node B (eNB) or gNB (5G base station). An eNB includes, for example, a macro eNB and a small eNB. The small eNB may be an eNB covering a cell smaller than a macro cell, such as a pico eNB, a micro eNB, or a home (femto) eNB. The gNB may have similar situations as above. Alternatively, the base station may be implemented as any other type of base station, such as a NodeB or a base transceiver station (BTS). The base station may include a body (which is also referred to as base station equipment) configured to control wireless communications and one or more remote radio heads (RRHs) arranged at a different place from the body. In addition, various types of user equipment can all operate as base stations by temporarily or semi-persistently performing base station functions.

The electronic apparatus 600 and 700 may be implemented as various user equipment. The user equipment may be implemented as a mobile terminal (such as a smart phone, a tablet personal computer (PC), a notebook PC, a portable game terminal, a portable/dongle-type mobile router, and a digital camera) or a vehicle-mounted terminal (such as an automobile navigation device). The user equipment may be implemented as a terminal that performs machine-to-machine (M2M) communications (which is also referred to as a machine type communication (MTC) terminal). Furthermore, the user equipment may be a wireless communication module (such as an integrated circuit module including a single chip) installed on each of the above-mentioned terminals. The user equipment may be further implemented as a robot, such as an unmanned aerial vehicle.

### [Application Examples of Base Station]

### First Application Example

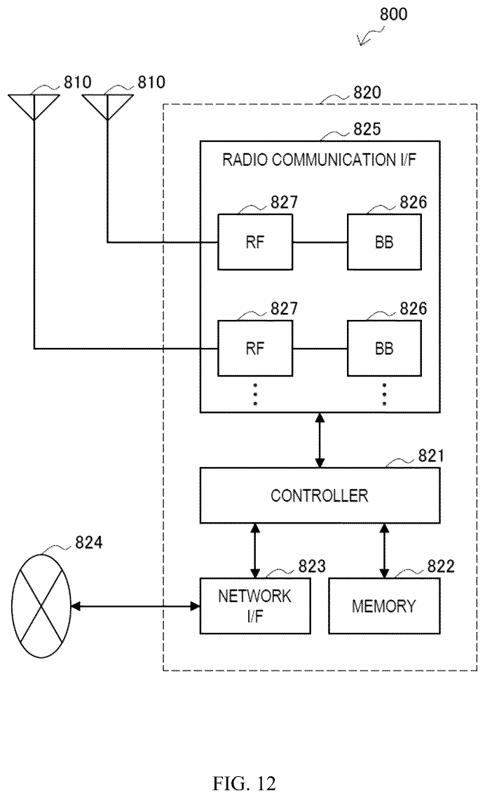

FIG. 12 is a block diagram showing a first example of a schematic configuration of an eNB or gNB to which the technology of the present disclosure can be applied. It should be noted that the following description is made taking an eNB as an example. The technology of the present disclosure is also applicable to a gNB. An eNB 800 includes one or more antennas 810 and base station equipment 820. The base station equipment 820 and each of the antennas 810 may be connected to each other via a RF cable.

Each of the antennas 810 includes a single or multiple antenna elements (such as multiple antenna elements included in a multi-input multi-output (MIMO) antenna), and is used for the base station equipment 820 to transmit and receive wireless signals. As shown in FIG. 12, the eNB 800 may include multiple antennas 810. For example, the multiple antennas 810 may be compatible with multiple frequency bands used by the eNB 800. Although FIG. 12 shows an example in which the eNB 800 includes multiple antennas 810, the eNB 800 may include a single antenna 810.

The base station equipment 820 includes a controller 821, a memory 822, a network interface 823, and a radio communication interface 825.

The controller 821 may be, for example, a CPU or DSP, and operates various functions of a higher layer of the base station equipment 820. For example, the controller 821 generates a data packet based on data in a signal processed by the radio communication interface 825, and transfers the generated packet via the network interface 823. The controller 821 may bundle data from multiple baseband processors to generate a bundled packet, and transfer the generated bundled packet. The controller 821 may have logical functions of performing control such as radio resource control, radio bearer control, mobility management, admission control, and scheduling. The control may be performed in conjunction with a nearby eNB or a core network node. The memory 822 includes an RAM and an ROM, and stores a program executed by the controller 821 and various types of control data (such as a terminal list, transmission power data, and scheduling data).

The network interface 823 is a communication interface for connecting the base station equipment 820 to a core network 824. The controller 821 may communicate with the core network node or another eNB via the network interface 823. In this case, the eNB 800 and the core network node or another eNB may be connected to each other through a logical interface (such as an SI interface and an X2 interface). The network interface 823 may be a wired communication interface or a radio communication interface for a wireless backhaul line. In a case that the network interface 823 is a radio communication interface, the network interface 823 may use a higher frequency band for wireless communications than a frequency band used by the radio communication interface 825.

The radio communication interface 825 supports any cellular communication scheme (such as Long-Term Evolution (LTE) and LTE-Advanced), and provides wireless connection to a terminal in a cell of the eNB 800 via the antenna 810. The radio communication interface 825 may typically include, for example, a baseband (BB) processor 86 and an RF circuit 827. The BB processor 86 may perform, for example, coding/decoding, modulation/demodulation and multiplexing/de-multiplexing, and perform various types of signal processes of layers (for example, layer 1, media access control (MAC), radio link control (RLC) and packet data convergence protocol (PDCP)). Instead of the controller 821, the BB processor 86 may have a part or all of the above-mentioned logical functions. The BB processor 86 may be a memory storing a communication control program, or a module including a processor and a related circuit configured to execute the program. Updating the program may change the functions of the BB processor 86. The module may be a card or blade inserted into a slot of the base station equipment 820. Alternatively, the module may be a chip mounted on the card or blade. In addition, the RF circuit 827 may include, for example, a mixer, a filter and an amplifier, and transmit and receive a wireless signal via the antenna 810.

As shown in FIG. 12, the radio communication interface 825 may include multiple BB processors 86. For example, the multiple BB processors 86 may be compatible with multiple frequency bands used by the eNB 800. As shown in FIG. 12, the radio communication interface 825 may include multiple RF circuits 827. For example, the multiple RF circuits 827 may be compatible with multiple antenna elements. Although FIG. 12 shows an example in which the radio communication interface 825 includes multiple BB processors 86 and multiple RF circuits 827, the radio communication interface 825 may include a single BB processor 86 or a single RF circuit 827.

In the eNB 800 as shown in FIG. 12, the electronic apparatuses 100 and 400, when implemented as base stations, have transceivers that may be implemented by the radio communication interface 825. At least a part of the functions may be implemented by the controller 821. For example, the controller 821 may determine the target task by executing the function of the unit in the electronic apparatus 100, and the controller 821 may trigger the request for processing a PDU session by executing the function of the unit in the electronic apparatus 400.

### Second Application Example

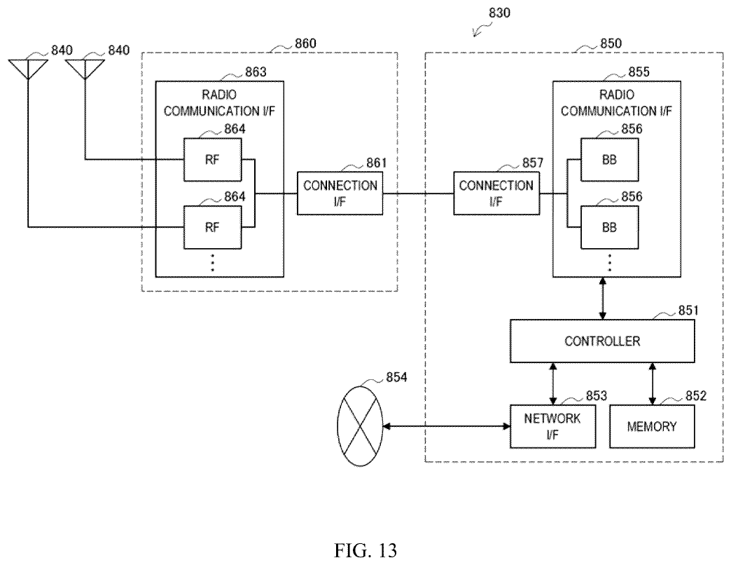

FIG. 13 is a block diagram showing a second example of a schematic configuration of an eNB or gNB to which the technology of the present disclosure can be applied. It should be noted that the following description is made taking the eNB as an example. The technology of the present disclosure is also applicable to the gNB. An eNB 830 includes a single or multiple antennas 840, base station equipment 850 and an RRH 860. The RRH 860 and each of the antennas 840 may be connected to each other via an RF cable. The base station equipment 850 and the RRH 860 may be connected to each other via a high-speed line such as an optical fiber cable.

Each of the antennas 840 includes a single or multiple antenna elements (such as multiple antenna elements included in a MIMO antenna), and is used for the RRH 860 to transmit and receive a wireless signal. As shown in FIG. 13, the eNB 830 may include multiple antennas 840. For example, the multiple antennas 840 may be compatible with multiple frequency bands used by the eNB 830. Although FIG. 13 shows an example in which the eNB 830 includes multiple antennas 840, the eNB 830 may include a single antenna 840.

The base station equipment 850 includes a controller 851, a memory 852, a network interface 853, a radio communication interface 855, and a connection interface 857. The controller 851, the memory 852, and the network interface 853 are the same as the controller 821, the memory 822, and the network interface 823 described with reference to FIG. 12.

The radio communication interface 855 supports any cellular communication scheme (such as LTE and LTE-advanced), and provides wireless communications to a terminal located in a sector corresponding to the RRH 860 via the RRH 860 and the antenna 840. The radio communication interface 855 may typically include, for example, a BB processor 856. The BB processor 856 is the same as the BB processor 86 described with reference to FIG. 12, except that the BB processor 856 is connected to an RF circuit 864 of the RRH 860 via the connection interface 857. As shown in FIG. 13, the radio communication interface 855 may include multiple BB processors 856. For example, the multiple BB processors 856 may be compatible with multiple frequency bands used by the eNB 830. Although FIG. 13 shows an example in which the radio communication interface 855 includes multiple BB processors 856, the radio communication interface 855 may include a single BB processor 856.

The connection interface 857 is an interface for connecting the base station equipment 850 (the radio communication interface 855) to the RRH 860. The connection interface 857 may be a communication module for communication in the above-described high-speed line that connects the base station equipment 850 (the radio communication interface 855) to the RRH 860.

The RRH 860 includes a connection interface 861 and a radio communication interface 863.

The connection interface 861 is an interface for connecting the RRH 860 (the radio communication interface 863) to the base station equipment 850. The connection interface 861 may also be a communication module for communication in the above-mentioned high-speed line.

The radio communication interface 863 transmits and receives wireless signals via the antenna 840. The radio communication interface 863 may typically include, for example, the RF circuit 864. The RF circuit 864 may include, for example, a mixer, a filter and an amplifier, and transmit and receive wireless signals via the antenna 840. As shown in FIG. 13, the radio communication interface 863 may include multiple RF circuits 864. For example, the multiple RF circuits 864 may support multiple antenna elements. Although FIG. 13 shows an example in which the radio communication interface 863 includes multiple RF circuits 864, the radio communication interface 863 may include a single RF circuit 864.

In the eNB 830 as shown in FIG. 13, the electronic apparatuses 100 and 400, when implemented as base stations, have transceivers that may be implemented by the radio communication interface 855. At least a part of the functions may be implemented by the controller 851. For example, the controller 851 may determine the target task by executing the function of the unit in the electronic apparatus 100, and the controller 851 may trigger the request for processing a PDU session by executing the function of the unit in the electronic apparatus 400.

### [Application Example of User Equipment]

### First Application Example

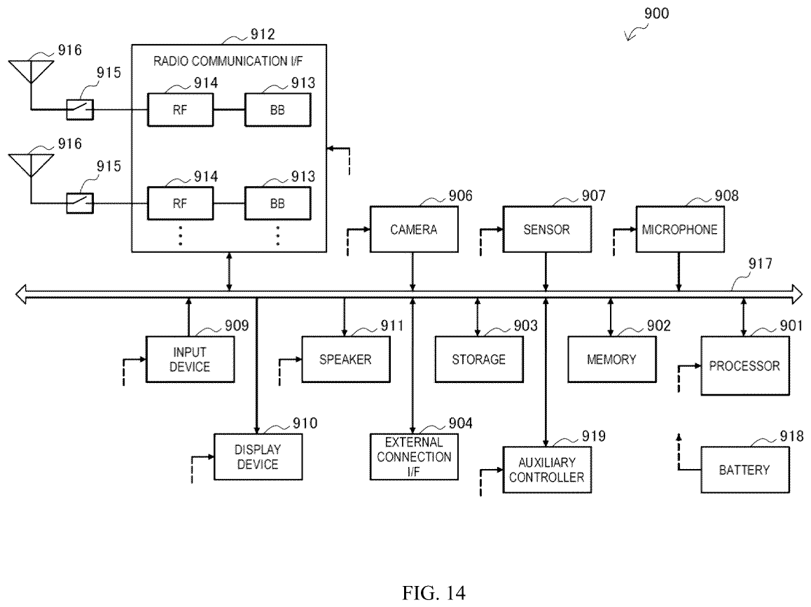

FIG. 14 is a block diagram showing an example of a schematic configuration of a smart phone 900 to which the technology of the present disclosure may be applied. The smart phone 900 includes a processor 901, a memory 902, a storage 903, an external connection interface 904, a camera 906, a sensor 907, a microphone 908, an input device 909, a display device 910, a speaker 911, a radio communication interface 912, one or more antenna switches 915, one or more antennas 916, a bus 917, a battery 918, and an auxiliary controller 919.

The processor 901 may be, for example, a CPU or a system on a chip (SoC), and controls the functions of the application layer and other layers of the smart phone 900. The memory 902 includes an RAM and an ROM, and stores data and programs executed by the processor 901. The storage 903 may include a storage medium such as a semiconductor memory and a hard disk. The external connection interface 904 is an interface for connecting an external device (such as a memory card and a universal serial bus (USB) device) to the smart phone 900.

The camera 906 includes an image sensor (such as a charge coupled device (CCD) and a complementary metal oxide semiconductor (CMOS)), and generates a captured image. The sensor 907 may include a group of sensors, such as a measurement sensor, a gyroscope sensor, a geomagnetic sensor, and an acceleration sensor. The microphone 908 converts sound inputted to the smart phone 900 into an audio signal. The input device 909 includes, for example, a touch sensor configured to detect a touch on a screen of the display device 910, a keypad, a keyboard, a button, or a switch, and receives an operation or information inputted from a user. The display device 910 includes a screen, such as a liquid crystal display (LCD) or an organic light emitting diode (OLED) display, and displays an output image of the smart phone 900. The speaker 911 converts the audio signal outputted from the smart phone 900 into sound.

The radio communication interface 912 supports any cellular communication scheme (such as LTE and LTE-Advanced), and performs wireless communications. The radio communication interface 912 may generally include, for example, a BB processor 913 and an RF circuit 914. The BB processor 913 may perform, for example, encoding/decoding, modulation/demodulation, and multiplexing/demultiplexing, and perform various types of signal processing for wireless communications. In addition, the RF circuit 914 may include, for example, a mixer, a filter or an amplifier, and transmit and receive a wireless signal via the antenna 916. It should be noted that, although the figure shows a situation where one RF link is connected to one antenna, this is only illustrative, and a situation where one RF link is connected to multiple antennas through multiple phase shifters is also possible. The radio communication interface 912 may be a chip module on which the BB processor 913 and the RF circuit 914 are integrated. As shown in FIG. 14, the radio communication interface 912 may include multiple BB processors 913 and multiple RF circuits 914. Although FIG. 14 shows an example in which the radio communication interface 912 includes multiple BB processors 913 and multiple RF circuits 914, the radio communication interface 912 may include a single BB processor 913 or a single RF circuit 914.

In addition to the cellular communication scheme, the radio communication interface 912 may support another type of wireless communication scheme, such as a short-range wireless communication scheme, a near field communication scheme, and a wireless local area network (LAN) scheme. In this case, the radio communication interface 912 may include a BB processor 913 and an RF circuit 914 for each wireless communication scheme.

Each of the antenna switches 915 switches a connection destination of the antenna 916 among multiple circuits (for example, circuits for different wireless communication schemes) included in the radio communication interface 912.

Each of the antennas 916 includes a single or multiple antenna elements (such as multiple antenna elements included in a MIMO antenna), and is configured for the radio communication interface 912 to transmit and receive wireless signals. As shown in FIG. 14, the smart phone 900 may include multiple antennas 916. Although FIG. 14 shows an example in which the smart phone 900 includes multiple antennas 916, the smart phone 900 may include a single antenna 916.

In addition, the smart phone 900 may include antenna(s) 916 for each wireless communication scheme. In this case, the antenna switches 915 may be omitted from the configuration of the smart phone 900.

The processor 901, the memory 902, the storage 903, the external connection interface 904, the camera 906, the sensor 907, the microphone 908, the input device 909, the display device 910, the speaker 911, the radio communication interface 912, and the auxiliary controller 919 are connected to each other via the bus 917. The battery 918 supplies power to each block of the smart phone 900 as shown in FIG. 14 via a feeder line. The feeder line is partially shown as a dashed line in the figure. The auxiliary controller 919 operates the least necessary function of the smart phone 900 in a sleep mode, for example.

In the smart phone 900 as shown in FIG. 14, in a case where the electronic apparatuses 600 and 700 are implemented, for example, as a smart phone on the user equipment side, the transceiver of the electronic apparatus 600 and 700 may be implemented by the radio communication interface 912. At least part of the functions may be implemented by the processor 901 or the auxiliary controller 919. For example, the processor 901 or the auxiliary controller 919 may send the task request to the network-side device by executing the function of the unit in the electronic apparatus 600, and the processor 901 or the auxiliary controller 919 may control the network-side device to trigger the request for processing a PDU session by executing the function of the unit in the electronic apparatus 700.

### Second Application Example

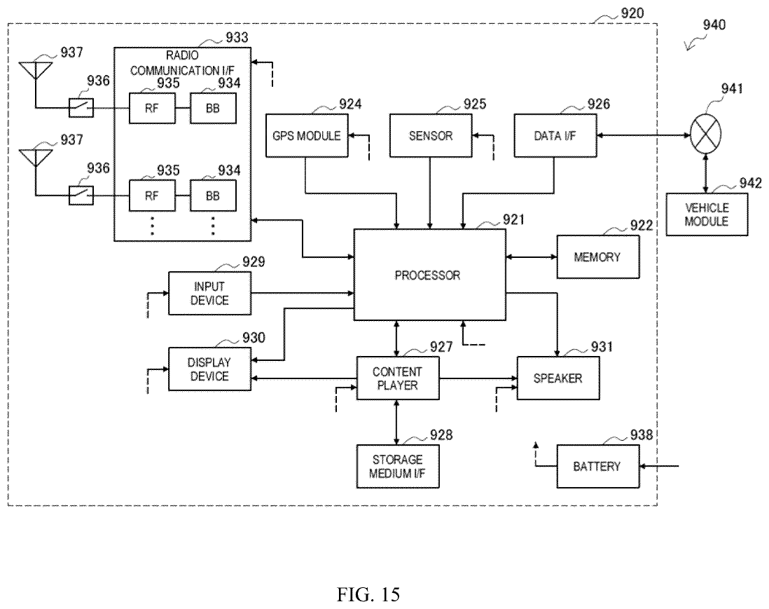

FIG. 15 is a block diagram showing an example of a schematic configuration of an automobile navigation device 920 to which the technology of the present disclosure may be applied. The automobile navigation device 920 includes a processor 921, a memory 922, a global positioning system (GPS) module 924, a sensor 925, a data interface 96, a content player 927, a storage medium interface 928, an input device 929, a display device 930, a speaker 931, a radio communication interface 933, one or more antenna switches 936, one or more antennas 937, and a battery 938.

The processor 921 may be, for example, a CPU or SoC, and controls the navigation function of the automobile navigation device 920 and other functions. The memory 922 includes an RAM and an ROM, and stores data and programs executed by the processor 921.

The GPS module 924 measures a position (such as latitude, longitude, and altitude) of the automobile navigation device 920 based on a GPS signal received from a GPS satellite. The sensor 925 may include a group of sensors, such as a gyroscope sensor, a geomagnetic sensor, and an air pressure sensor. The data interface 96 is connected to, for example, an in-vehicle network 941 via a terminal not shown, and acquires data (such as vehicle speed data) generated by a vehicle.

The content player 927 reproduces content stored in a storage medium (such as a CD and a DVD) inserted into the storage medium interface 928. The input device 929 includes, for example, a touch sensor configured to detect a touch on a screen of the display device 930, a button, or a switch, and receives an operation or information inputted from the user. The display device 930 includes a screen such as an LCD or OLED display, and displays an image of a navigation function or reproduced content. The speaker 931 outputs a sound of the navigation function or the reproduced content.

The radio communication interface 933 supports any cellular communication scheme (such as LTE and LTE-Advanced), and performs wireless communications. The radio communication interface 933 may generally include, for example, a BB processor 934 and an RF circuit 935. The BB processor 934 may perform, for example, encoding/decoding, modulation/demodulation, and multiplexing/demultiplexing, and perform various types of signal processing for wireless communications. In addition, the RF circuit 935 may include, for example, a mixer, a filter or an amplifier, and transmit and receive a wireless signal via the antenna 937. The radio communication interface 933 may be a chip module on which the BB processor 934 and the RF circuit 935 are integrated. As shown in FIG. 15, the radio communication interface 933 may include multiple BB processors 934 and multiple RF circuits 935. Although FIG. 15 shows an example in which the radio communication interface 933 includes multiple BB processors 934 and multiple RF circuits 935, the radio communication interface 933 may include a single BB processor 934 or a single RF circuit 935.

In addition to the cellular communication scheme, the radio communication interface 933 may support another type of wireless communication scheme, such as a short-range wireless communication scheme, a near field communication scheme, or a wireless LAN scheme. In this case, the radio communication interface 933 may include a BB processor 934 and an RF circuit 935 for each wireless communication scheme.

Each of the antenna switches 936 switches a connection destination of the antenna 937 among multiple circuits (such as circuits for different wireless communication schemes) included in the radio communication interface 933.

Each of the antennas 937 includes a single or multiple antenna elements (such as multiple antenna elements included in a MIMO antenna), and is configured for the radio communication interface 933 to transmit and receive wireless signals. As shown in FIG. 15, the automobile navigation device 920 may include multiple antennas 937. Although FIG. 15 shows an example in which the automobile navigation device 920 includes multiple antennas 937, the automobile navigation device 920 may include a single antenna 937.

In addition, the automobile navigation device 920 may include antenna(s) 937 for each wireless communication scheme. In this case, the antenna switches 936 may be omitted from the configuration of the automobile navigation device 920.

The battery 938 supplies power to blocks of the automobile navigation device 920 shown in FIG. 15 via a feeder line. The feeder line is partially shown as a dashed line in the figure. The battery 938 accumulates electric power supplied from the vehicle.

In the automobile navigation device 920 as shown in FIG. 15, in a case where the electronic apparatuses 600 and 700 is implemented, for example, as an automobile navigation device on the user equipment side, the transceiver of the electronic apparatus 600 and 700 may be implemented by the radio communication interface 933. At least part of the functions may be implemented by the processor 921. For example, the processor 921 may send the task request to the network-side device by executing the function of the unit in the electronic apparatus 600, and the processor 921 may control the network-side device to trigger the request for processing a PDU session by executing the function of the unit in the electronic apparatus 700.

The technology of the present disclosure may also be implemented as an in-vehicle system (or vehicle) 940 including the vehicle navigation device 920, an in-vehicle network 941, and one or more blocks of vehicle modules 942. The vehicle modules 942 generate vehicle data (such as vehicle speed, engine speed, and failure information), and outputs the generated data to the in-vehicle network 941.

Basic principles of the present disclosure are described above in conjunction with the specific embodiments. However, it should be noted that those skilled in the art can understand that all or any of steps or components of the methods and apparatuses of the present disclosure can be implemented in any computing device (including processors, storage media, and the like) or a network of computing devices in a form of hardware, firmware, software or a combination thereof. Such implementation can be realized by those skilled in the art after reading the description of the present disclosure, by utilizing basic knowledge of circuit design or basic programming skills.

Moreover, a program product storing machine-readable instruction codes is further provided according to an embodiment of the present disclosure. The instruction codes, when read and executed by a machine, may implement the methods according to the embodiments of the present disclosure.

Accordingly, a storage medium for carrying the program product storing the machine-readable instruction codes is further included in the present disclosure. The storage medium includes, but is not limited to, a floppy disk, an optical disk, a magneto-optical disk, a storage card, a memory stick, and the like.

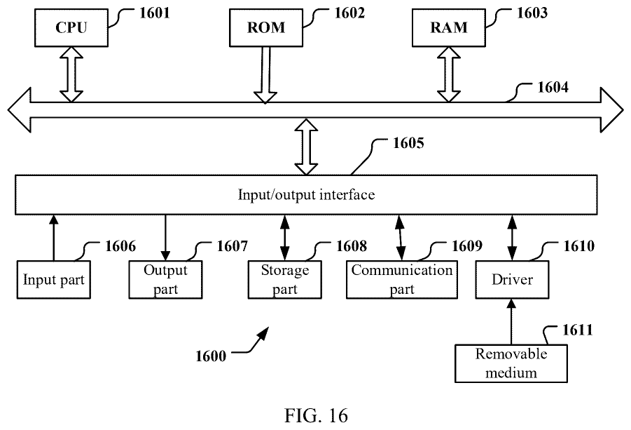

In a case of implementing the embodiments of the present disclosure in software or firmware, the program consisting of the software is mounted to a computer with a dedicated hardware structure (such as a general-purpose personal computer 1600 as shown in FIG. 16) from the storage medium or network. The computer, when mounted with various programs, performs various functions.

In FIG. 16, a central processing unit (CPU) 1601 executes various processes according to a program stored in a read-only memory (ROM) 1602 or a program loaded from a storage part 1608 to a random-access memory (RAM) 1603. In the RAM 1603, data required for the CPU 1601 to perform various processes or the like is stored as necessary. The CPU 1601, the ROM 1602 and the RAM 1603 are connected to each other via a bus 1604. An input/output interface 1605 is connected to the bus 1604.

The following components are connected to the input/output interface 1605: an input part 1606 (including a keyboard, a mouse, and the like), an output part 1607 (including a display, such as a cathode ray tube (CRT) and a liquid crystal display (LCD), a loudspeaker, and the like), a storage part 1608 (including a hard disk and the like), and a communication part 1609 (including a network interface card, such as a LAN card, and a modem). The communication part 1609 performs communication processing via a network, such as the Internet. A driver 1610 may be connected to the input/output interface 1605 as needed. A removable medium 1611, such as a magnetic disk, an optical disk, a magnetic optical disk, and a semiconductor memory, is mounted to the driver 1610 as required, so that a computer program read therefrom is mounted to the storage part 1608 as required.

In a case that the above processes are implemented by software, the program consisting of the software is mounted from a network, such as the Internet, or from a storage medium, such as the removable medium 1611.

Those skilled in the art should understood that, the storage medium is not limited to the removable medium 1611, as shown in FIG. 16, which stores a program and is distributed separately from the apparatus so as to provide the program for a user. Examples of the removable medium 1611 includes a magnetic disk (including a floppy disk (registered trademark)), an optical disk (including a compact disk read-only memory (CD-ROM) and a Digital Versatile Disk (DVD)), a magneto-optical disk (including a mini disk (MD) (registered trademark)), and a semiconductor memory. Alternatively, the storage medium may be the ROM 1602, the hard disk contained in the storage part 1608, or the like. The storage medium stores a program and is distributed to the user along with an apparatus in which the storage medium is incorporated.

It should be further noted that components or steps in the apparatus, method and system of the present disclosure can be decomposed and/or recombined. Such decomposition and/or recombination should be considered equivalents of the present disclosure. Furthermore, steps for executing the above processes may naturally be executed in a chronological order as described, but do not necessarily need to be executed in the chronological order. Certain steps may be performed in parallel with or independently of each other.

Finally, it should be noted that terms “include”, “comprise” or any other variants are intended to be non-exclusive. Therefore, a process, method, article or device including a series of elements includes not only the elements but also other elements that are not enumerated, or further includes elements inherent to the process, method, article or device. In addition, unless expressively limited otherwise, the statement “comprising (including) a (n) . . . ” does not exclude existence of other similar elements in the process, method, article or device.

Although the embodiments of the present disclosure are described in detail above with reference to the accompanying drawings, it should be understood that the embodiments are only for illustrating the present disclosure and do not constitute a limitation to the present disclosure. For those skilled in the art, various modifications and changes can be made to the embodiments without departing from the spirit and scope of the present disclosure. Therefore, the scope of the present disclosure is limited by only the appended claims and equivalents thereof.

The present technology may be implemented as the following solutions.
Solution 1. An electronic apparatus for wireless communications, comprising:
processing circuitry configured to determine, based on a task request received from user equipment located within a service range of the electronic apparatus, at least one target task to be initiated for the user equipment,
wherein each target task is performed according to a corresponding work mode, and
the task request comprises a task list having the at least one target task and a list indicating a priority of the work mode.
Solution 2. The electronic apparatus according to solution 1, wherein
each target task is divided into one or more task segments according to time and/or geographic area; and
in each task segment, a sub-target task comprised in the target task and corresponding to the task segment is performed, and the sub-target task is performed according to a corresponding sub-work mode comprised in the work mode for performing the target task.
Solution 3. The electronic apparatus according to solution 2, wherein in each task segment, a sub-target task corresponding to the task segment is suspended or switched if any sub-work mode is interrupted.
Solution 4. The electronic apparatus according to solution 2 or 3, wherein
the target task comprises a mobility target task in which the user equipment reaches a predetermined geographical location and/or a motionless target task in which the user equipment works within a predetermined area.
Solution 5. The electronic apparatus according to solution 4, wherein
the predetermined geographical location comprises one or more geographical locations arranged sequentially and/or by priority.
Solution 6. The electronic apparatus according to any one of solutions 2 to 5, wherein
the target task has a corresponding backup task, and the backup task is a task to be performed in place of the target task when the target task is unable to be performed.
Solution 7. The electronic apparatus according to solution 6, wherein the processing circuitry is configured to generate the backup task based on a backup task request sent by the user equipment.
Solution 8. The electronic apparatus according to solution 7, wherein the backup task request comprises information regarding whether the user equipment accepts to determine the backup task by the electronic apparatus.
Solution 9. The electronic apparatus according to solution 8, wherein the backup task request further comprises information regarding whether the user equipment continues performing the target task.
Solution 10. The electronic apparatus according to solution 8 or 9, wherein the backup task request further comprises a redundancy requirement regarding the backup task.
Solution 11. The electronic apparatus according to any one of solutions 8 to 10, wherein the target task is switched to a corresponding backup task when a predetermined switching trigger condition and/or predetermined switching trigger time is satisfied.
Solution 12. The electronic apparatus according to solution 11, wherein the predetermined switching trigger condition comprises at least one of a notification message trigger, a network resource threshold trigger, a geographical location trigger, and a timing trigger.
Solution 13. The electronic apparatus according to solution 11 or 12, wherein the predetermined switching trigger time comprises pre-switching of performing switching before the target task being unable to be performed or post-switching of performing switching after the target task being unable to be performed.
Solution 14. The electronic apparatus according to any one of solutions 6 to 13, wherein the backup task comprises sub-backup tasks respectively corresponding to sub-target tasks in the target task.
Solution 15. The electronic apparatus according to solution 14, wherein
the processing circuitry is configured to perform resource allocation for each sub-target task and a sub-backup task corresponding to the sub-target task.
Solution 16. The electronic apparatus according to solution 15, wherein the processing circuitry is configured to:
reserve resources for performing all sub-backup tasks, and at each time point of being going to enter each task segment, book a resource for performing a sub-target task corresponding to the task segment.
Solution 17. The electronic apparatus according to solution 15, wherein the processing circuitry is configured to:
at a time point of being going to enter an earliest task segment which is the earliest in time, book a resource for performing a sub-target task corresponding to the earliest task segment, and reserve resources for performing a sub-backup task corresponding to the earliest task segment and a sub-backup task corresponding to a next task segment, and
at a time point of being going to enter each task segment other than the earliest task segment, book a resource for performing a sub-target task corresponding to the task segment, and reserve a resource for performing a sub-backup task corresponding to a next task segment.
Solution 18. The electronic apparatus according to solution 15, wherein the processing circuitry is configured to:
at each time point of being going to enter each task segment, book a resource for performing a sub-target task corresponding to the task segment, and reserve a resource for performing a sub-backup task corresponding to the task segment.
Solution 19. The electronic apparatus according to any one of solutions 16 to 18, wherein the processing circuitry is configured to:
after the user equipment enters a next task segment from a sub-target task in a current task segment, release a resource booked for performing a sub-target task corresponding to the task segment and release a resource reserved for performing a sub-backup task corresponding to the task segment.
Solution 20. The electronic apparatus according to any one of solutions 6 to 19, wherein the backup task is restored to the target task when a predetermined restoration condition is satisfied.
Solution 21. The electronic apparatus according to any one of solutions 2 to 20, wherein the processing circuitry is configured to determine the target task based on resources managed by the electronic apparatus.
Solution 22. The electronic apparatus according to solution 21, wherein the resources managed comprise at least one of network communication resources, computing power resources, sensing capability resources, and work collaboration resources corresponding to the work mode.
Solution 23. The electronic apparatus according to solution 22, wherein the network communication resources comprise at least one of: a frequency band bandwidth resource of a Uu interface, a signal reflection resource of a reconfigurable intelligence surface, a relay capability resource of relay user equipment, and a contiguous PC5 coverage resources within the task segment.
Solution 24. The electronic apparatus according to solution 22 or 23, wherein the work collaboration resources comprise capability resources of other entities, which are different from the electronic apparatus and the user equipment, required for performing the target task.
Solution 25. The electronic apparatus according to any one of solutions 2 to 24, wherein the processing circuitry is configured to determine a sub-work mode corresponding to the task segment according to geographical location information corresponding to the task segment.
Solution 26. The electronic apparatus according to any one of solutions 1 to 25, wherein the user equipment is a vehicle operated and/or driven remotely.
Solution 27. The electronic apparatus according to solution 26, wherein the work mode comprises one of single-vehicle autonomous driving, formation driving, autonomous driving, remote monitoring, direct remote control, indirect remote control, and manual manipulation.
Solution 28. The electronic apparatus according to any one of solutions 1 to 25, wherein the user equipment is an unmanned aerial vehicle.
Solution 29. The electronic apparatus according to solution 28, wherein the work mode comprises one of autonomous driving, formation driving, remote monitoring, direct remote control, indirect remote control, and manual manipulation.
Solution 30. The electronic apparatus according to any one of solutions 1 to 25, wherein the user equipment is a robot.
Solution 31. An electronic apparatus for wireless communications, comprising:
processing circuitry configured to trigger a request for processing a protocol data unit (PDU) session when user equipment located within a service range of the electronic apparatus is to switch from a current task to a to-be-switched task,
wherein a first QoS flow in a first PDU session corresponding to the current task is related to a second QoS flow in a second PDU session corresponding to the to-be-switched task.
Solution 32. The electronic apparatus according to solution 31, wherein
the request comprises a modification request for the first PDU session, and
the modification request for the first PDU session triggers modification of the first Qos flow, and triggers a modification request for the second PDU session or an establishment request for the second PDU session.
Solution 33. The electronic apparatus according to solution 32, wherein the modification request for the second PDU session triggers modification of the second PDU session and/or the second Qos flow.
Solution 34. The electronic apparatus according to solution 32 or 33, wherein the establishment request for the second PDU session triggers establishment of the second PDU session and the second Qos flow.
Solution 35. The electronic apparatus according to solution 31, wherein
the request comprises a release request for the first PDU session, and
the release request for the first PDU session triggers release of the first Qos flow, and triggers an establishment request for the second PDU session.
Solution 36. The electronic apparatus according to solution 35, wherein the establishment request for the second PDU session triggers establishment of the second PDU session and the second Qos flow.
Solution 37. The electronic apparatus according to any one of solutions 32 to 34, wherein an information element is added to the modification request for the first PDU session, and the information element comprises an identifier of the second PDU session and information about the second Qos flow.
Solution 38. The electronic apparatus according to solution 35 or 36, wherein an information element is added to the release request for the first PDU session, and the information element comprises an identifier of the second PDU session and information about the second Qos flow.
Solution 39. The electronic apparatus according to solution 37 or 38, wherein the information about the second Qos flow comprises an ID of the second Qos flow, and a to-be-processed parameter of the second Qos flow.
Solution 40. The electronic apparatus according to any one of solutions 31 to 39, wherein
the current task and the to-be-switched task belong to a target task, and
the target task is performed according to a corresponding work mode.
Solution 41. The electronic apparatus according to solution 40, wherein
the target task is divided into one or more task segments in time; and
in each task segment, a sub-target task comprised in the target task and corresponding to the task segment is performed, and the sub-target task is performed according to a corresponding sub-work mode comprised in the work mode for performing the target task.
Solution 42. The electronic apparatus according to solution 41, wherein the processing circuitry is configured to detect, for at least one task segment of the one or more task segments, exception information related to execution of corresponding sub-target task within the task segment, to detect an abnormality in the user equipment.
Solution 43. The electronic apparatus according to solution 42, wherein the exception information comprises an abnormality of a data flow rate of the user equipment within the task segment.
Solution 44. The electronic apparatus according to solution 42, wherein
the exception information comprises an abnormality of computing resources and/or abnormality of sensing resources of the user equipment within the task segment, and
the abnormality of sensing resources comprises one of the following: non-usage of the resources within a predetermined period of time, interference on a sensing capability, and decrease of accuracy of the sensing capability.
Solution 45. The electronic apparatus according to solution 42, wherein the exception information comprises information about an abnormality of the user equipment reported within the task segment by an apparatus for performing the sub-target task.
Solution 46. The electronic apparatus according to any one of solutions 31 to 45, wherein the user equipment is a vehicle operated and/or driven remotely.
Solution 47. The electronic apparatus according to solution 46, wherein
the user equipment performs the current task or the to-be-switched task according to a corresponding work mode, and
the work mode comprises one of single-vehicle autonomous driving, formation driving, autonomous driving, remote monitoring, direct remote control, indirect remote control, and manual manipulation.
Solution 48. The electronic apparatus according to any one of solutions 31 to 45, wherein the user equipment is an unmanned aerial vehicle.
Solution 49. The electronic apparatus according to solution 48, wherein
the user equipment performs the current task or the to-be-switched task according to a corresponding work mode, and
the work mode comprises one of autonomous driving, formation driving, remote monitoring, direct remote control, indirect remote control, and manual manipulation.
Solution 50. The electronic apparatus according to any one of solutions 31 to 45, wherein the user equipment is a robot.
Solution 51. An electronic apparatus for wireless communications, comprising:
processing circuitry configured to send a task request to a network-side device serving the electronic apparatus, for the network-side device to determine at least one target task to be initiated for the electronic apparatus,
wherein each target task is performed according to a corresponding work mode, and
the task request comprises a task list having the at least one target task and a list indicating a priority of the work mode.
Solution 52. The electronic apparatus according to solution 51, wherein
each target task is divided into one or more task segments according to time and/or geographic area; and
in each task segment, a sub-target task comprised in the target task and corresponding to the task segment is performed, and the sub-target task is performed according to a corresponding sub-work mode comprised in the work mode for performing the target task.
Solution 53. The electronic apparatus according to solution 52, wherein in each task segment, a sub-target task corresponding to the task segment is suspended or switched if any sub-work mode is interrupted.
Solution 54. The electronic apparatus according to solution 52 or 53, wherein
the target task comprises a mobility target task in which the electronic apparatus reaches a predetermined geographical location and/or a motionless target task in which the electronic apparatus works within a predetermined area.
Solution 55. The electronic apparatus according to solution 54, wherein
the predetermined geographical location comprises one or more geographical locations arranged sequentially and/or by priority.
Solution 56. The electronic apparatus according to any one of solutions 52 to 55, wherein
the target task has a corresponding backup task, and the backup task is a task to be performed in place of the target task when the target task is unable to be performed.
Solution 57. The electronic apparatus according to solution 56, wherein the processing circuitry is configured to send a backup task request to the network-side device, for the network-side device to generate the backup task.
Solution 58. The electronic apparatus according to solution 57, wherein the backup task request comprises information regarding whether the electronic apparatus accepts to determine the backup task by the network-side device.
Solution 59. The electronic apparatus according to solution 58, wherein the backup task request further comprises information regarding whether the electronic apparatus continues performing the target task.
Solution 60. The electronic apparatus according to solution 58 or 59, wherein the backup task request further comprises a redundancy requirement regarding the backup task.
Solution 61. The electronic apparatus according to any one of solutions 58 to 60, wherein the target task is switched to a corresponding backup task when a predetermined switching trigger condition and/or predetermined switching trigger time is satisfied.
Solution 62. The electronic apparatus according to solution 61, wherein the predetermined switching trigger condition comprises at least one of a notification message trigger, a network resource threshold trigger, a geographical location trigger, and a timing trigger.
Solution 63. The electronic apparatus according to solution 61 or 62, wherein the predetermined switching trigger time comprises pre-switching of performing switching before the target task being unable to be performed or post-switching of performing switching after the target task being unable to be performed.
Solution 64. The electronic apparatus according to any one of solutions 56 to 63, wherein the backup task comprises sub-backup tasks respectively corresponding to sub-target tasks in the target task.
Solution 65. The electronic apparatus according to solution 64, wherein resources required to perform each sub-target task and a sub-backup task corresponding to the sub-target task are allocated by the network-side device.
Solution 66. The electronic apparatus according to solution 65, wherein the resources are allocated by the network-side device in the following manner:
reserving resources for performing all sub-backup tasks, and
at each time point of being going to enter each task segment, booking a resource for performing a sub-target task corresponding to the task segment.
Solution 67. The electronic apparatus according to solution 65, wherein the resources are allocated by the network-side device in the following manner:
at a time point of being going to enter an earliest task segment which is the earliest in time, booking a resource for performing a sub-target task corresponding to the earliest task segment, and reserving resources for performing a sub-backup task corresponding to the earliest task segment and a sub-backup task corresponding to a next task segment, and
at a time point of being going to enter each task segment other than the earliest task segment, booking a resource for performing a sub-target task corresponding to the task segment, and reserving a resource for performing a sub-backup task corresponding to a next task segment.
Solution 68. The electronic apparatus according to solution 65, wherein the resources are allocated by the network-side device in the following manner:
at each time point of being going to enter each task segment, booking a resource for performing a sub-target task corresponding to the task segment, and reserving a resource for performing a sub-backup task corresponding to the task segment.
Solution 69. The electronic apparatus according to any one of solutions 66 to 68, wherein after the electronic apparatus enters a next task segment from a sub-target task in a current task segment, the network-side device releases a resource booked for performing a sub-target task corresponding to the task segment and releases a resource reserved for performing a sub-backup task corresponding to the task segment.
Solution 70. The electronic apparatus according to any one of solutions 56 to 69, wherein the backup task is restored to the target task when a predetermined restoration condition is satisfied.
Solution 71. The electronic apparatus according to any one of solutions 52 to 70, wherein the target task is determined by the network-side device based on resources managed by the network-side device.
Solution 72. The electronic apparatus according to solution 71, wherein the resources managed comprise at least one of network communication resources, computing power resources, sensing capability resources, and work collaboration resources corresponding to the work mode.
Solution 73. The electronic apparatus according to solution 72, wherein the network communication resources comprise at least one of: a frequency band bandwidth resource of a Uu interface, a signal reflection resource of a reconfigurable intelligence surface, a relay capability resource of a relay electronic apparatus, and a contiguous PC5 coverage resources within the task segment.
Solution 74. The electronic apparatus according to solution 72 or 73, wherein the work collaboration resources comprise capability resources of other entities, which are different from the electronic apparatus and the network-side device, required for performing the target task.
Solution 75. The electronic apparatus according to any one of solutions 52 to 74, wherein a sub-work mode corresponding to the task segment is determined by the network-side device according to geographical location information corresponding to the task segment.
Solution 76. The electronic apparatus according to any one of solutions 51 to 75, wherein the electronic apparatus is a vehicle operated and/or driven remotely.
Solution 77. The electronic apparatus according to solution 76, wherein the work mode comprises one of single-vehicle autonomous driving, formation driving, autonomous driving, remote monitoring, direct remote control, indirect remote control, and manual manipulation.
Solution 78. The electronic apparatus according to any one of solutions 51 to 75, wherein the electronic apparatus is an unmanned aerial vehicle.
Solution 79. The electronic apparatus according to solution 78, wherein the work mode comprises one of autonomous driving, formation driving, remote monitoring, direct remote control, indirect remote control, and manual manipulation.
Solution 80. The electronic apparatus according to any one of solutions 51 to 75, wherein the electronic apparatus is a robot.
Solution 81. An electronic apparatus for wireless communications, comprising:
processing circuitry configured to cause, when the electronic apparatus is to switch from a current task to a to-be-switched task, a network-side device serving the electronic apparatus to trigger a request for processing a protocol data unit (PDU) session,
wherein a first QoS flow in a first PDU session corresponding to the current task is related to a second QoS flow in a second PDU session corresponding to the to-be-switched task.
Solution 82. The electronic apparatus according to solution 81, wherein
the request comprises a modification request for the first PDU session, and
the modification request for the first PDU session triggers modification of the first Qos flow, and triggers a modification request for the second PDU session or an establishment request for the second PDU session.
Solution 83. The electronic apparatus according to solution 82, wherein the modification request for the second PDU session triggers modification of the second PDU session and/or the second Qos flow.
Solution 84. The electronic apparatus according to solution 82 or 83, wherein the establishment request for the second PDU session triggers establishment of the second PDU session and the second Qos flow.
Solution 85. The electronic apparatus according to solution 81, wherein
the request comprises a release request for the first PDU session, and
the release request for the first PDU session triggers release of the first Qos flow, and triggers an establishment request for the second PDU session.
Solution 86. The electronic apparatus according to solution 85, wherein the establishment request for the second PDU session triggers establishment of the second PDU session and the second Qos flow.
Solution 87. The electronic apparatus according to any one of solutions 82 to 84, wherein an information element is added to the modification request for the first PDU session, and the information element comprises an identifier of the second PDU session and information about the second Qos flow.
Solution 88. The electronic apparatus according to solution 85 or 86, wherein an information element is added to the release request for the first PDU session, and the information element comprises an identifier of the second PDU session and information about the second Qos flow.
Solution 89. The electronic apparatus according to solution 87 or 88, wherein the information about the second Qos flow comprises an ID of the second Qos flow, and a to-be-processed parameter of the second Qos flow.
Solution 90. The electronic apparatus according to any one of solutions 81 to 89, wherein
the current task and the to-be-switched task belong to a target task, and
the target task is performed according to a corresponding work mode.
Solution 91. The electronic apparatus according to solution 90, wherein
the target task is divided into one or more task segments in time; and
in each task segment, a sub-target task comprised in the target task and corresponding to the task segment is performed, and the sub-target task is performed according to a corresponding sub-work mode comprised in the work mode for performing the target task.
Solution 92. The electronic apparatus according to solution 91, wherein exception information related to execution of a sub-target task within at least one task segment of the one or more task segments is detected by the network-side device, to detect an abnormality in the electronic apparatus.
Solution 93. The electronic apparatus according to solution 92, wherein the exception information comprises an abnormality of a data flow rate of the electronic apparatus within the task segment.
Solution 94. The electronic apparatus according to solution 92, wherein
the exception information comprises an abnormality of computing resources and/or abnormality of sensing resources of the electronic apparatus within the task segment, and
the abnormality of sensing resources comprises one of the following: non-usage of the resources within a predetermined period of time, interference on a sensing capability, or decrease of accuracy of the sensing capability.
Solution 95. The electronic apparatus according to solution 92, wherein the exception information comprises information about an abnormality of the electronic apparatus reported within the task segment by an apparatus for performing the sub-target task.
Solution 96. The electronic apparatus according to any one of solutions 81 to 95, wherein the electronic apparatus is a vehicle operated and/or driven remotely.
Solution 97. The electronic apparatus according to solution 96, wherein
the electronic apparatus performs the current task or the to-be-switched task according to a corresponding work mode, and
the work mode comprises one of single-vehicle autonomous driving, formation driving, autonomous driving, remote monitoring, direct remote control, indirect remote control, and manual manipulation.
Solution 98. The electronic apparatus according to any one of solutions 81 to 95, wherein the electronic apparatus is an unmanned aerial vehicle.
Solution 99. The electronic apparatus according to solution 98, wherein
the electronic apparatus performs the current task or the to-be-switched task according to a corresponding work mode, and
the work mode comprises one of autonomous driving, formation driving, remote monitoring, direct remote control, indirect remote control, and manual manipulation.
Solution 100. The electronic apparatus according to any one of solutions 81 to 95, wherein the electronic apparatus is a robot.
Solution 101. A method for wireless communications, comprising:
determining, based on a task request received from user equipment located within a service range of an electronic apparatus, at least one target task to be initiated for the user equipment,
wherein each target task is performed according to a corresponding work mode, and
the task request comprises a task list having the at least one target task and a list indicating a priority of the work mode.
Solution 102. A method for wireless communications, comprising:
triggering a request for processing a protocol data unit (PDU) session when user equipment located within a service range of an electronic apparatus is to switch from a current task to a to-be-switched task,
wherein a first QoS flow in a first PDU session corresponding to the current task is related to a second QoS flow in a second PDU session corresponding to the to-be-switched task.
Solution 103. A method for wireless communications, comprising:
sending a task request to a network-side device serving an electronic apparatus, for the network-side device to determine at least one target task to be initiated for the electronic apparatus,
wherein each target task is performed according to a corresponding work mode, and
the task request comprises a task list having the at least one target task and a list indicating a priority of the work mode.
Solution 104. A method for wireless communications, comprising:
causing, when an electronic apparatus is to switch from a current task to a to-be-switched task, a network-side device serving the electronic apparatus to trigger a request for processing a protocol data unit (PDU) session,
wherein a first QoS flow in a first PDU session corresponding to the current task is related to a second QoS flow in a second PDU session corresponding to the to-be-switched task.
Solution 105. A computer-readable storage medium having computer-executable instructions stored thereon that, when the computer-executable instructions are executed, perform the method for wireless communications according to any one of solutions 101 to 104.

1. An electronic apparatus for wireless communications, comprising
at least one processor; and
at least one memory including computer program code, where the at least one memory and the computer program code are configured, with the at least one processor, to cause the electronic apparatus to at least:
determine, based on a task request received from user equipment located within a service range of the electronic apparatus, at least one target task to be initiated for the user equipment,
wherein each target task is performed according to a corresponding work mode, and
the task request comprises a task list having the at least one target task and a list indicating a priority of the work mode.

2. The electronic apparatus according to claim 1, wherein
each target task is divided into one or more task segments according to time and/or geographic area; and
in each task segment, a sub-target task comprised in the target task and corresponding to the task segment is performed, and the sub-target task is performed according to a corresponding sub-work mode comprised in the work mode for performing the target task.

3. The electronic apparatus according to claim 2, wherein in each task segment, a sub-target task corresponding to the task segment is suspended or switched if any sub-work mode is interrupted.

4. The electronic apparatus according to claim 2, wherein
the target task comprises a mobility target task in which the user equipment reaches a predetermined geographical location and/or a motionless target task in which the user equipment works within a predetermined area.

5. The electronic apparatus according to claim 4, wherein
the predetermined geographical location comprises one or more geographical locations arranged sequentially and/or by priority.

6. The electronic apparatus according to claim 2, wherein
the target task has a corresponding backup task, and the backup task is a task to be performed in place of the target task when the target task is unable to be performed.

7. The electronic apparatus according to claim 6, wherein the at least one memory and the computer program code are configured, with the at least one processor, to cause the electronic apparatus to generate the backup task based on a backup task request sent by the user equipment.

8. The electronic apparatus according to claim 7, wherein the backup task request comprises information regarding whether the user equipment accepts to determine the backup task by the electronic apparatus.

9. The electronic apparatus according to claim 8, wherein the backup task request further comprises information regarding whether the user equipment continues performing the target task.

10. The electronic apparatus according to claim 8, wherein the backup task request further comprises a redundancy requirement regarding the backup task.

11. The electronic apparatus according to claim 8, wherein the target task is switched to a corresponding backup task when a predetermined switching trigger condition and/or predetermined switching trigger time is satisfied.

12. The electronic apparatus according to claim 11, wherein the predetermined switching trigger condition comprises at least one of a notification message trigger, a network resource threshold trigger, a geographical location trigger, and a timing trigger.

13. The electronic apparatus according to claim 11, wherein the predetermined switching trigger time comprises pre-switching of performing switching before the target task being unable to be performed or post-switching of performing switching after the target task being unable to be performed.

14. The electronic apparatus according to claim 6, wherein the backup task comprises sub-backup tasks respectively corresponding to sub-target tasks in the target task.

15. The electronic apparatus according to claim 14, wherein
the at least one memory and the computer program code are configured, with the at least one processor, to cause the electronic apparatus to perform resource allocation for each sub-target task and a sub-backup task corresponding to the sub-target task.

16. The electronic apparatus according to claim 15, wherein the at least one memory and the computer program code are configured, with the at least one processor, to cause the electronic apparatus to:
reserve resources for performing all sub-backup tasks, and
at each time point of being going to enter each task segment, book a resource for performing a sub-target task corresponding to the task segment, or
at a time point of being going to enter an earliest task segment which is the earliest in time, book a resource for performing a sub-target task corresponding to the earliest task segment, and reserve resources for performing a sub-backup task corresponding to the earliest task segment and a sub-backup task corresponding to a next task segment, and
at a time point of being going to enter each task segment other than the earliest task segment, book a resource for performing a sub-target task corresponding to the task segment, and reserve a resource for performing a sub-backup task corresponding to a next task segment, or
at each time point of being going to enter each task segment, book a resource for performing a sub-target task corresponding to the task segment, and reserve a resource for performing a sub-backup task corresponding to the task segment.

17-18. (canceled)

19. The electronic apparatus according to claim 16, wherein the at least one memory and the computer program code are configured, with the at least one processor, to cause the electronic apparatus to:
after the user equipment enters a next task segment from a sub-target task in a current task segment, release a resource booked for performing a sub-target task corresponding to the task segment and release a resource reserved for performing a sub-backup task corresponding to the task segment.

20. The electronic apparatus according to claim 6, wherein the backup task is restored to the target task when a predetermined restoration condition is satisfied.

21-30. (canceled)

31. An electronic apparatus for wireless communications, comprising:
at least one processor; and
at least one memory including computer program code, where the at least one memory and the computer program code are configured, with the at least one processor, to cause the electronic apparatus to at least:
trigger a request for processing a protocol data unit (PDU) session when user equipment located within a service range of the electronic apparatus is to switch from a current task to a to-be-switched task,
wherein a first QoS flow in a first PDU session corresponding to the current task is related to a second QoS flow in a second PDU session corresponding to the to-be-switched task.

32-50. (canceled)

51. An electronic apparatus for wireless communications, comprising
at least one processor; and
at least one memory including computer program code, where the at least one memory and the computer program code are configured, with the at least one processor, to cause the electronic apparatus to at least:
send a task request to a network-side device serving the electronic apparatus, for the network-side device to determine at least one target task to be initiated for the electronic apparatus,
wherein each target task is performed according to a corresponding work mode, and
the task request comprises a task list having the at least one target task and a list indicating a priority of the work mode.

52-105. (canceled)
